(19) United States
(12) Patent Application Publication
(10) Pub. No.: US 2009/0228838 A1
(43) Pub. Date: Sep. 10, 2009

(54) CONTENT DESIGN TOOL

(76) Inventors: Christopher N. Ryan, Windham, NH (US); Daniel Gobera Rubalcava, Cupertino, CA (US); Michael Kahl, Austin, TX (US); Kevin Lindeman, Vancouver, WA (US); Han Ming Ong, San Jose, CA (US)

Correspondence Address: FISH & RICHARDSON P.C., PO BOX 1022, MINNEAPOLIS, MN, 55440-1022, US

(21) Appl. No.: 12/165,525

(22) Filed: Jun. 30, 2008

Related U.S. Application Data
(60) Provisional application No. 61/033,775, filed on Mar. 4, 2008.
(60) Provisional application No. 61/034,129, filed on Mar. 5, 2008.

(51) Int. Cl. G06F 3/048; G06F 15/173

(52) U.S. Cl. 715/853; 715/764; 709/224; 709/223

(57) ABSTRACT

Among other disclosed subject matter, a method includes providing a user interface allowing the insertion of elements into a document flow comprising static and dynamic elements, the user interface presenting a graphical depiction of the document that is dynamically altered by the insertion of the element, wherein the dynamically altered appearance of the document correctly reflects the position and type of the inserted element and rearranges all existing static and flow elements of the document around the inserted element.

### PRIORITY APPLICATIONS

This patent application claims priority to U.S. Provisional Application No. 61/033,775 filed on Mar. 4, 2008 and U.S. Provisional Application No. 61/034,129 filed on Mar. 5, 2008, the contents of both of which are incorporated by reference.

### RELATED APPLICATIONS

This patent application is related to John Louch et al., U.S. patent application Ser. No. 11/145,577, Widget Authoring and Editing Environment, which is incorporated herein by reference.

This patent application is related to Chris Rudolph et al., U.S. patent application Ser. No. 11/834,578, Web Widgets, which is incorporated herein by reference.

### BACKGROUND

Widgets are known in the art and may be found for example as part of Mac OS X in Dashboard. An application such as Apple Inc.'s Dashcode 1.0 (described in an Appendix) may be used to assist in the creation of Widgets. Web applications are known in the art and may run on mobile devices such as the Apple iPhone. Often it is desirable to create content that may alternatively run as a widget or as a web application. There are often common aspects to widget creation and web application creation.

The invention relates to content design.

In a first aspect, a method includes providing a user interface allowing the insertion of elements into a document flow comprising static and dynamic elements, the user interface presenting a graphical depiction of the document that is dynamically altered by the insertion of the element, wherein the dynamically altered appearance of the document correctly reflects the position and type of the inserted element and rearranges all existing static and flow elements of the document around the inserted element.

Implementations can include any, all or none of the following features. The user interface can be configured to insert into the document flow any element from a predefined library containing at least a box element, a browser element, a button element, an input control element, a gauge element, and combinations thereof. The user interface can be configured to insert into the document flow elements and non-flow elements. The user interface can provide that an underlying code of the document flow is modified based on the inserted element and the rearranged static and dynamic elements.

In a second aspect, a method includes detecting the movement of an element of a layout of a document outside a boundary of a first level of hierarchy; and visually and in the underlying code, placing that element in a level of hierarchy that is a parent of the first level of hierarchy.

Implementations can include any, all or none of the following features. The movement can begin in another element at the first level that is configured to contain the element at the first level, and the movement outside the boundary can include that the element is placed at the parent of the first level instead of being placed at the first level. A user can graphically move the element by dragging the element using a pointing device.

In a third aspect, a method includes refactoring an interface for content editing based on a project type.

Implementations can include any, all or none of the following features. The project type can be defined using a property list for the project type. The method can further include providing at least one of templates, attributes, library parts, views, icons, variable elements based on the project type. The method can further include choosing a deployment behavior based on the project type. The refactoring can be performed in a tool that includes templates for web applications and for web widgets, and a user can select one of the templates in the tool and the property list is provided from the selected template. The tool can provide a list view and at least one template row, and the method can further include receiving a modification of the template row and applying the modification to any other row that relates to the template row. The method can further include adding an element to the list view, adding the element to the template row, and updating all rows of the list relating to the template row.

In a fourth aspect, a method includes generating a replicated element based on the editing of a canonical element and mapping corresponding subcomponents of the canonical element to corresponding subcomponents of the replicated elements. The method can further include maintaining a dictionary to map identifiers of a subcomponent of a replicated element to an identifier of a subcomponent of the canonical element. The method can further include invoking a function that receives a cloned row relating to a template row, the cloned row having an attribute that contains a reference to each element in the cloned row, wherein the function changes an aspect of the cloned row based on the attribute.

In a fifth aspect, a method includes: running a debug plug in in a mobile device to monitor a web application and reporting data to a web application development tool.

Implementations can include any, all or none of the following features. The method can further include presenting a resource logging interface for the web application, the resource logging interface configured to be filtered. The method can further include providing graphical representations of memory, CPU and network use to indicate CPU usage or memory.

In a sixth aspect, a method includes: running a debug plug in a simulator of a mobile device to monitor a web application and reporting data to a web application development tool.

Implementations can include any, all or none of the following features. The method can further include monitoring a web application on both a mobile device and on a simulation of a mobile device connected to a debugging interface using plug-ins in a browser of the mobile device and a browser of the simulation of the mobile device. The method can further include presenting a resource logging interface for the web application, the resource logging interface configured to be filtered. The method can further include providing graphical representations of memory, CPU and network use to indicate CPU usage or memory.

In a seventh aspect, a method includes: depicting content intended for a mobile device at a scale related to the pixel resolution of the device in a simulation of the device.

Implementations can include any, all or none of the following features. The depicted content can be a pixel-to-pixel analog of the mobile device. The method can further include resealing to a 1:1 dimensionally accurate analog of a view on the mobile device.

In an eighth aspect, a method includes: depicting content intended for a mobile device at a scale related to the physical dimensions the device in a simulation of the device.

Implementations can include any, all or none of the following features. The method can further include simulating a rotation to be performed on the mobile device. Simulating the rotation can include determining, before simulating the rotation, each aspect of the depicted content; determining how each aspect should appear after rotation on the mobile device; and performing the rotation based on at least on the two determinations.

In a ninth aspect, a method to allow a visualization of content intended for a mobile device at a first scale related to the pixel resolution of the device in a simulation of the device or at a second scale related to the physical dimensions the device in the simulation of the device in response to a user input.

Implementations can include any, all or none of the following features. The method can further include selectively performing the visualization at at least one of the first scale or the second scale. The visualization can be performed at one of the first and second scales based on a user input.

In a tenth aspect, a method includes: listing all resources accessed by a web application or a web widget and filtering them based on one or more of network location and resource type.

Implementations can include any, all or none of the following features. A user can select one of the resources, and the method can further include displaying information regarding the selected resource. The method can further include toggling to display the resource instead of the displayed information.

In an eleventh aspect, a method includes displaying information comprising CPU, memory and network bandwidth usage of only those processes required to display or run a particular web application or widget.

Implementations can include any, all or none of the following features. The information can be displayed in a debug plug in in a mobile device that monitors a web application and reports data to a web application development tool. The information can be displayed in a debug plug in in a simulator of a mobile device that monitors a web application and reports data to a web application development tool.

### DESCRIPTION OF DRAWINGS

In this application, the drawings are listed in the order in which the described figures appear in the description below.

FIGS. 3A and 3B depict refactoring of a user interface for a content creation tool in an implementation.

FIGS. 4A and 4B depict a user interface for web application creation in an implementation.

FIGS. 5A and 5B depict a user interface for widget creation in an implementation

FIGS. 1.1 through 1.8 depict a user interaction with a content creation tool to insert elements into a document in one implementation.

FIGS. 2.1 through 2.7 depict a user interaction with a content creation tool to insert elements into a document in an implementation.

FIGS. 12A-12C depict automatic replication of sub-components and sub-structure based on editing a canonical component

FIGS. 9A and 9B depict switching from pixel based scaling to dimension based scaling in one embodiment.

FIGS. 28A-28E depict rotation of content for a fixed size window in an implementation

FIGS. 26A and 26B depict a stacked layout in a document creation process in an implementation.

FIGS. 27A and 27B depict the running of a stacked layout in an implementation.

FIG. 11 is a diagram of a tool user interface to record and view local and network resources used by a web application or a widget.

FIG. 10 is a diagram of the software architecture of a web application and widget authoring system.

FIG. 7 is an example software stack for implementing the features and processes described herein.

FIG. 8 is an example system for implementing the features and processes described herein.

FIGS. 25A and 25B is a user interface for mobile device that can implement the invention.

FIG. 30 is a hardware architecture of the mobile device of FIGS. 25A & 25B for implementing the invention.

### DETAILED DESCRIPTION

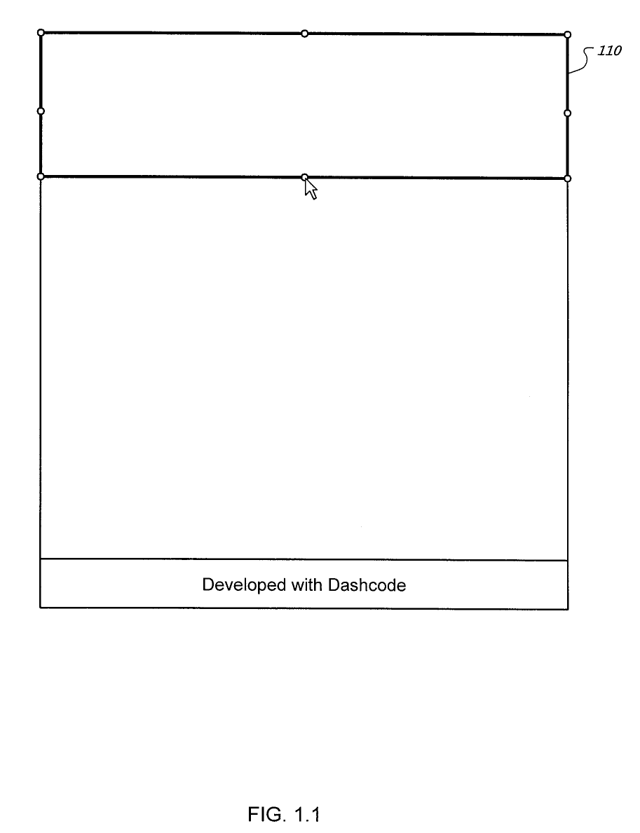

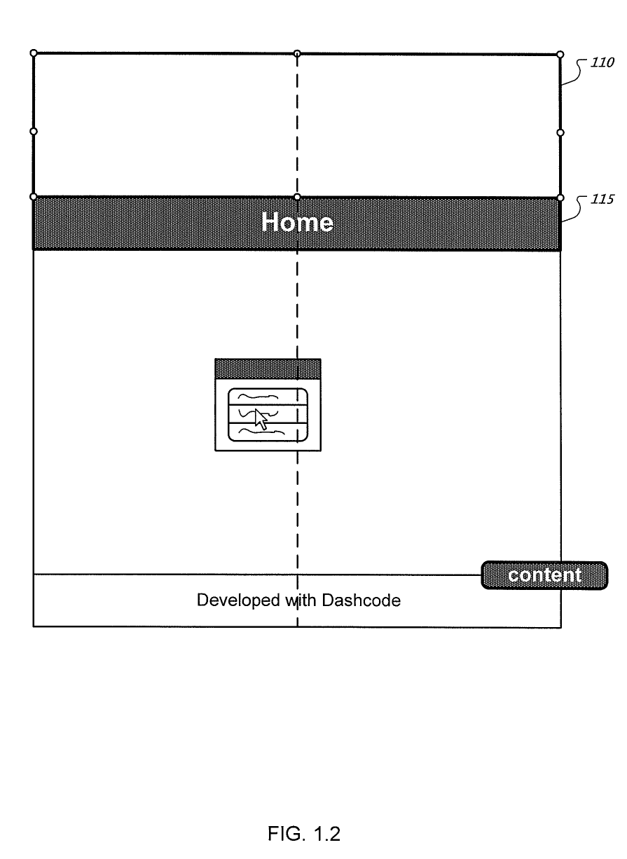

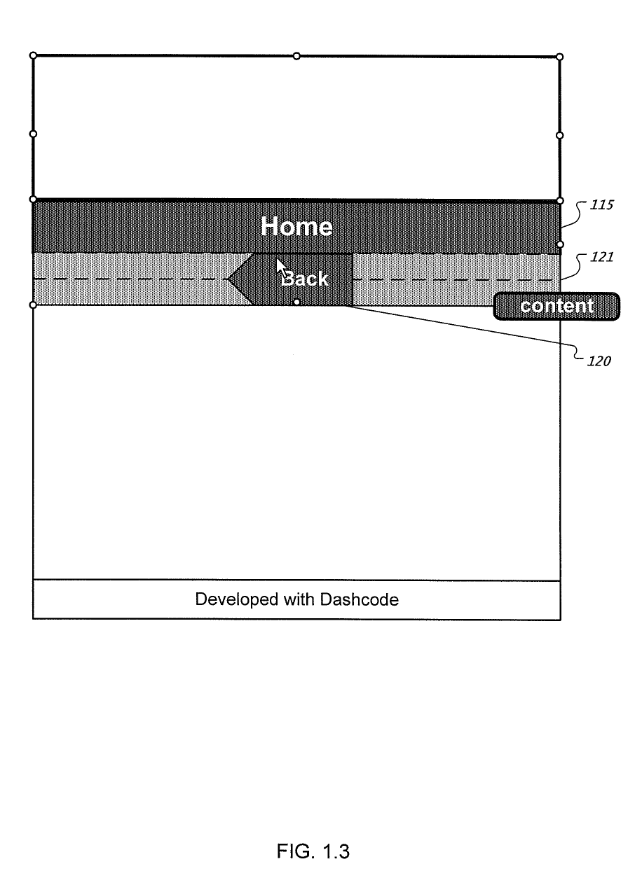

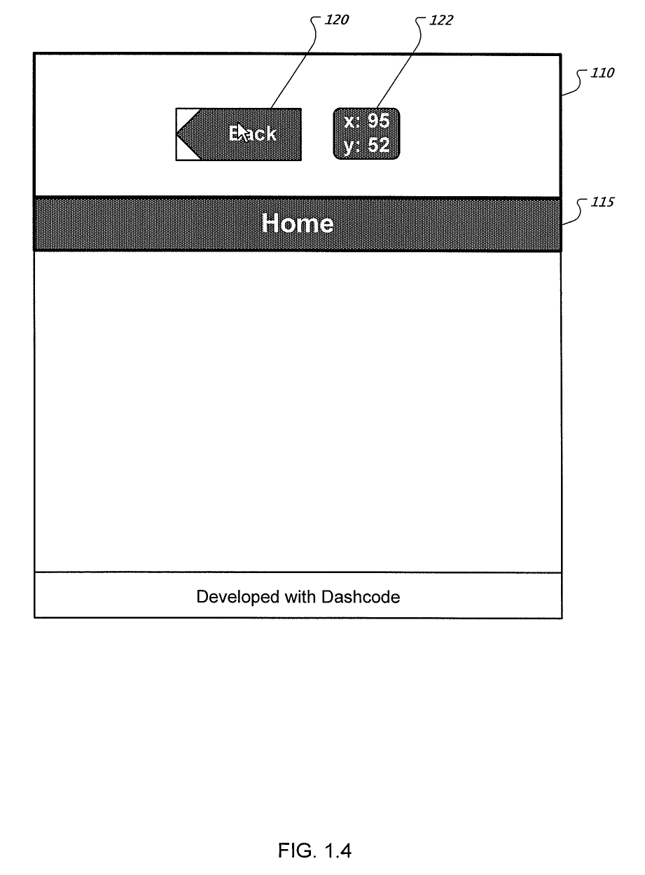

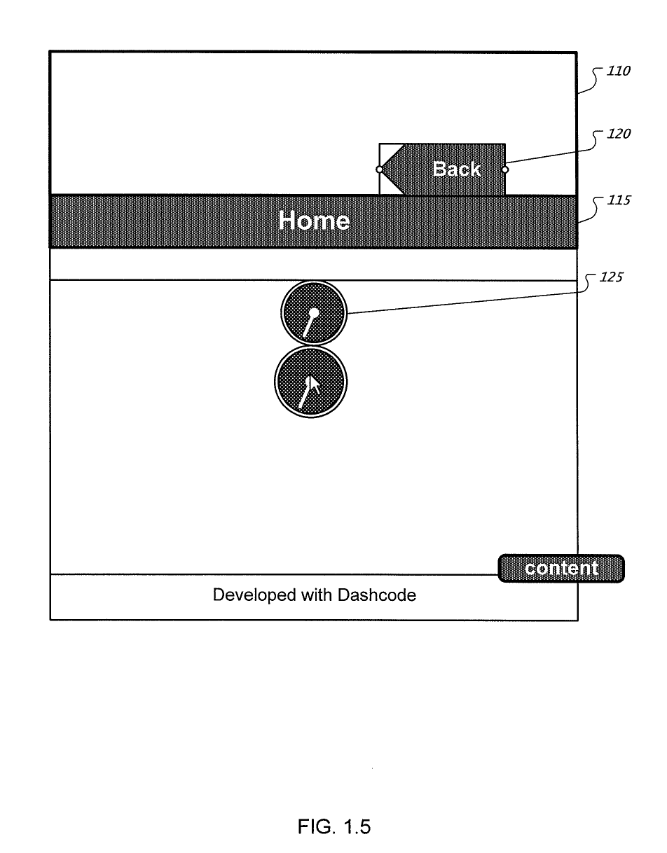

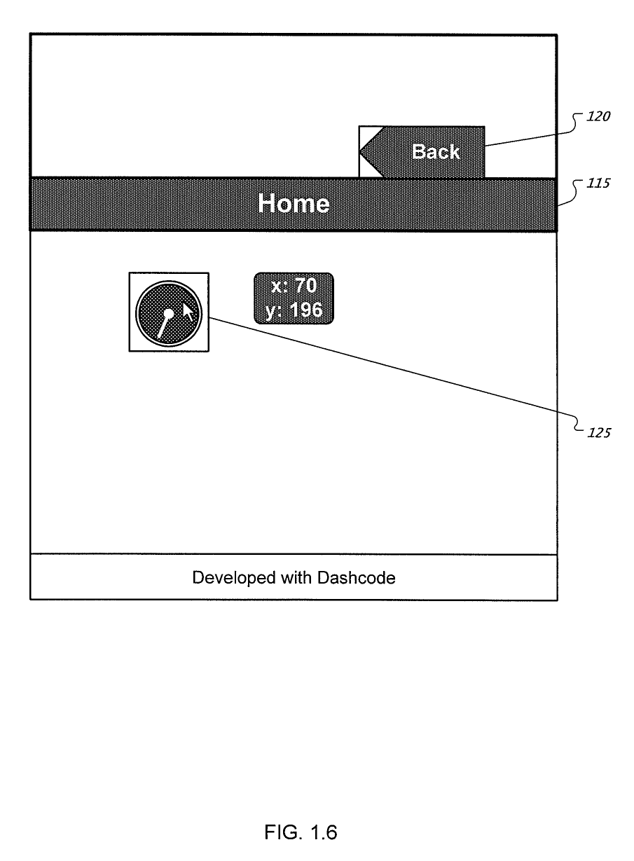

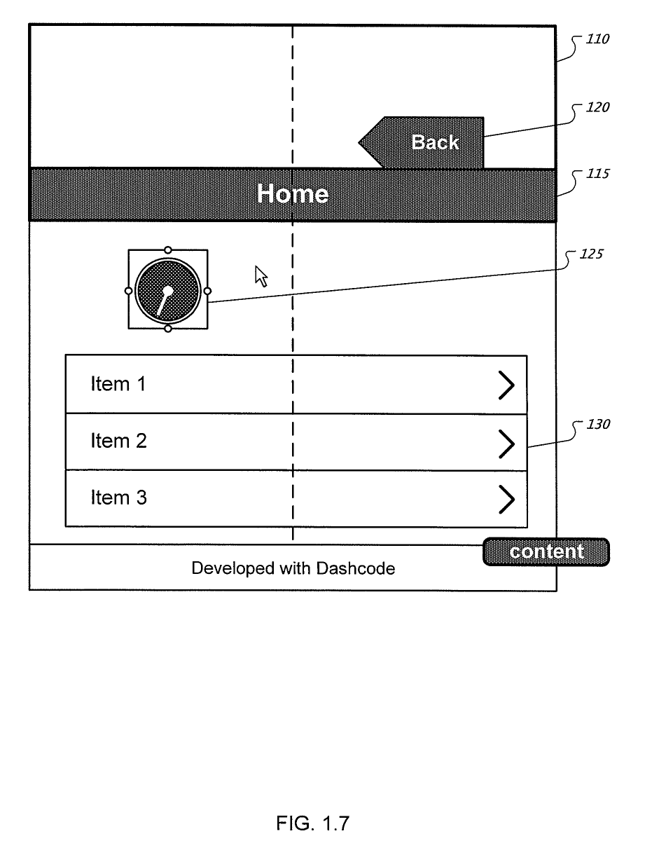

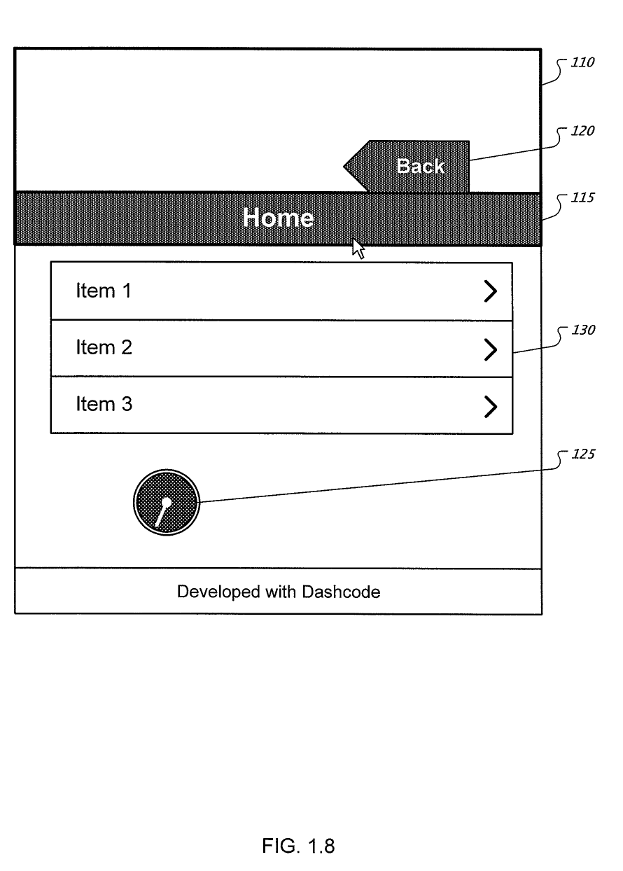

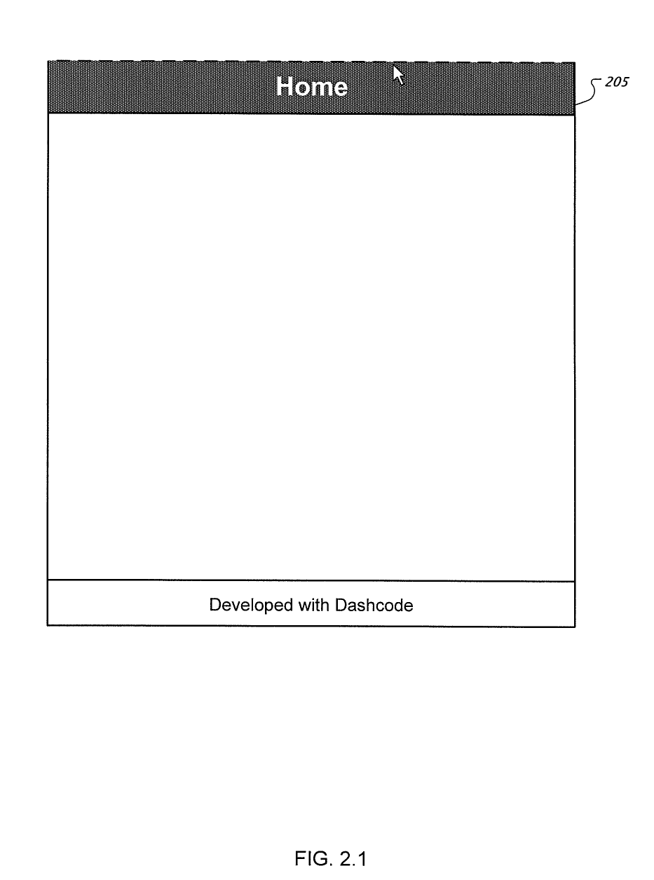

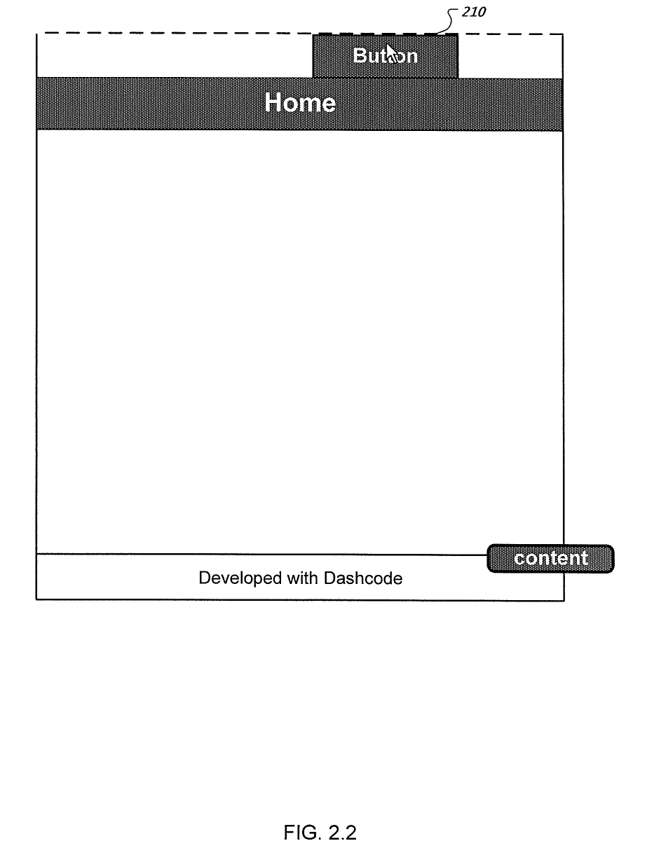

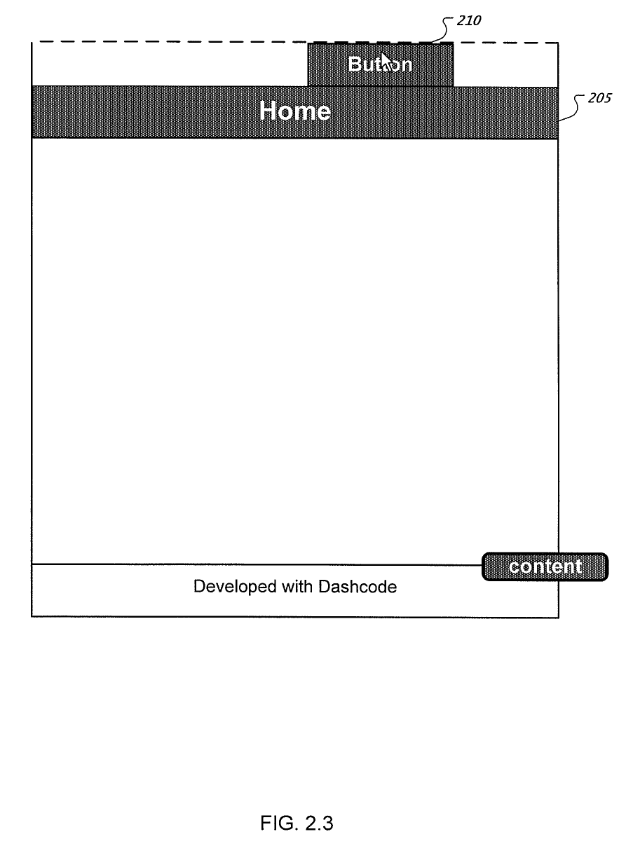

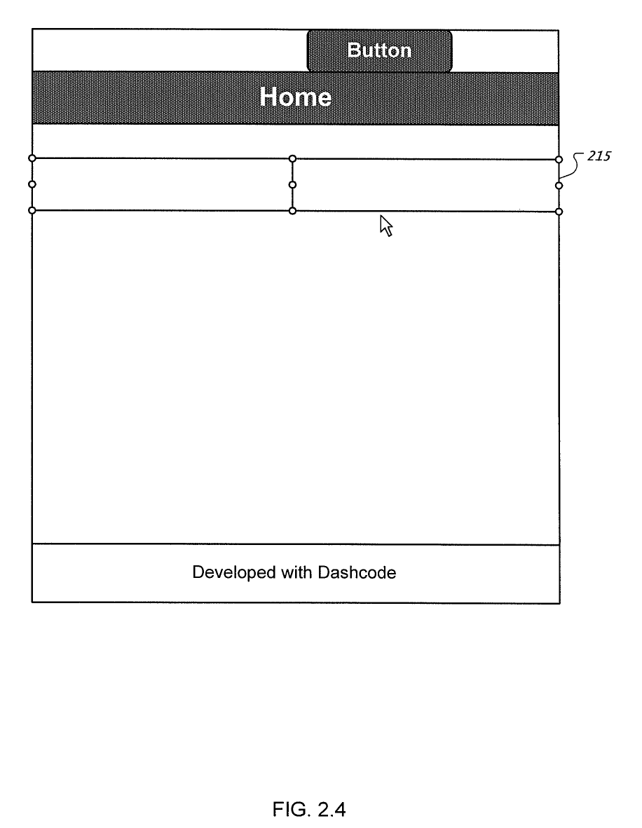

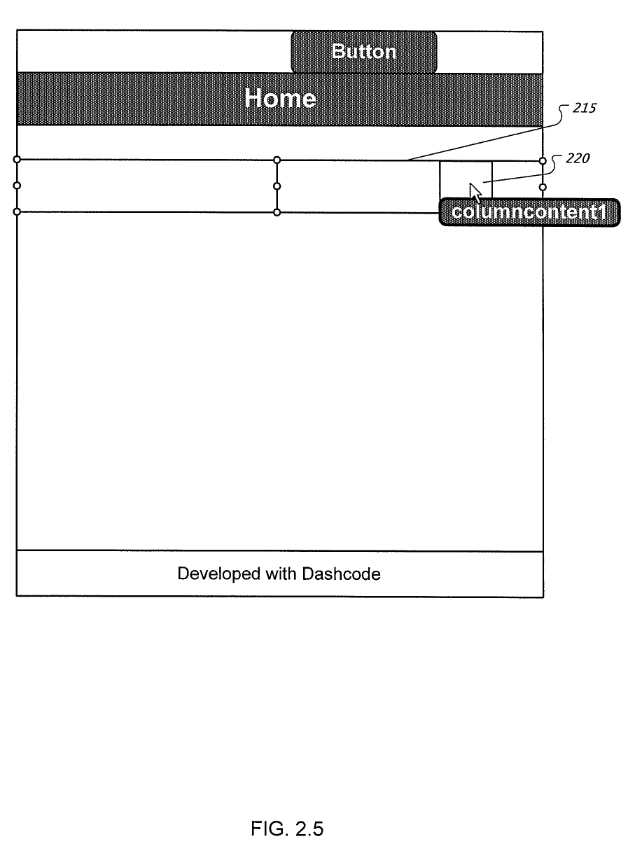

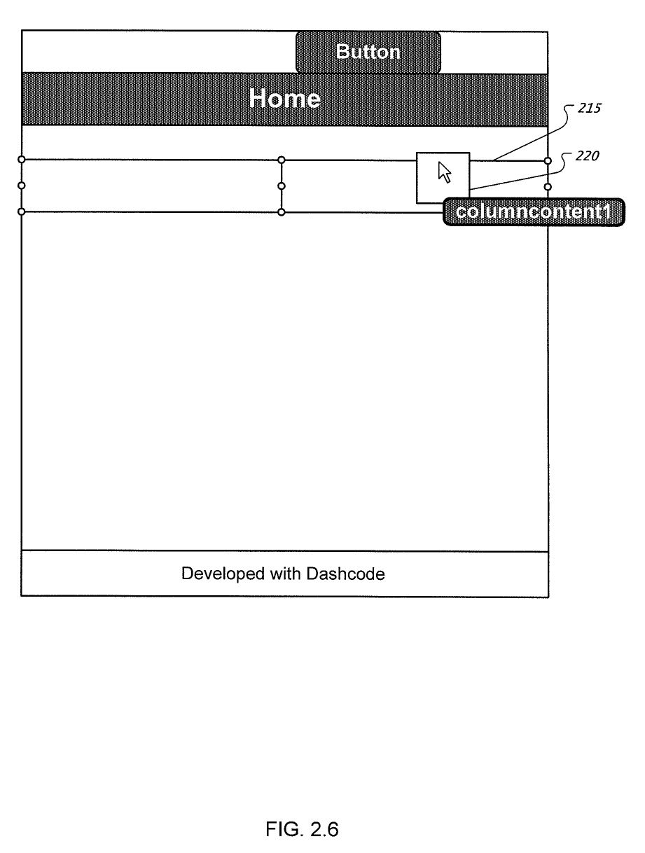

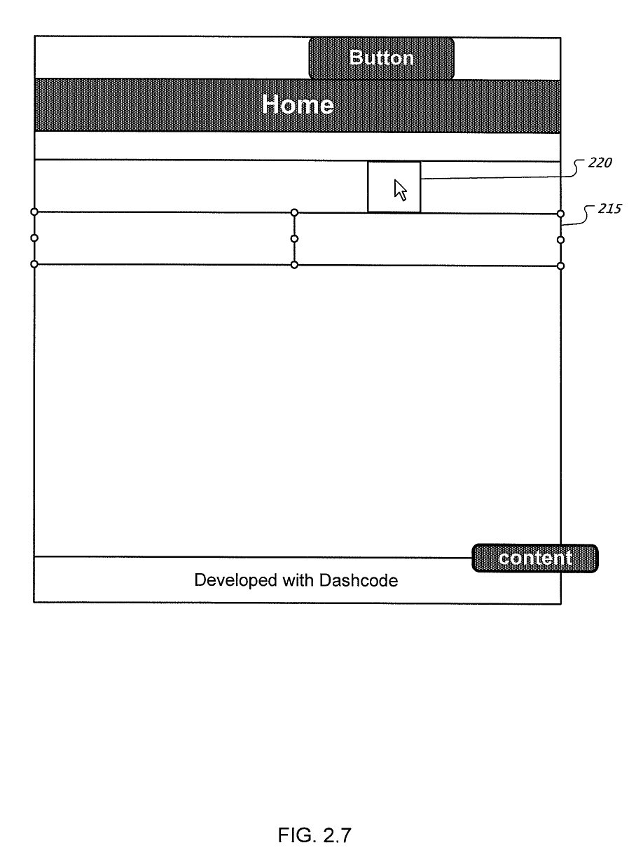

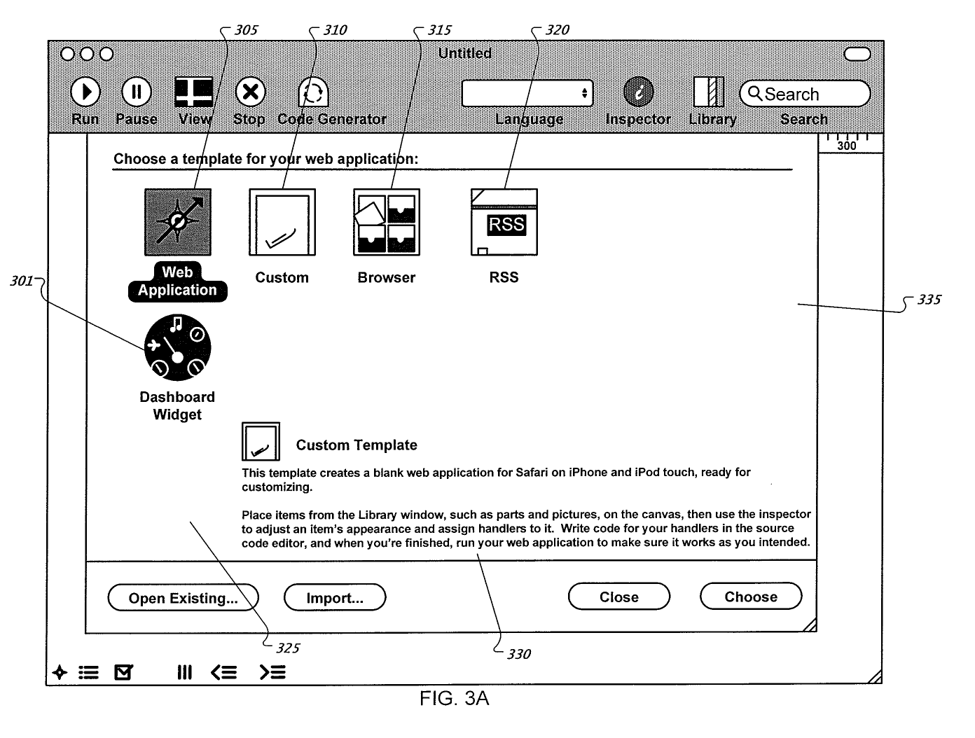

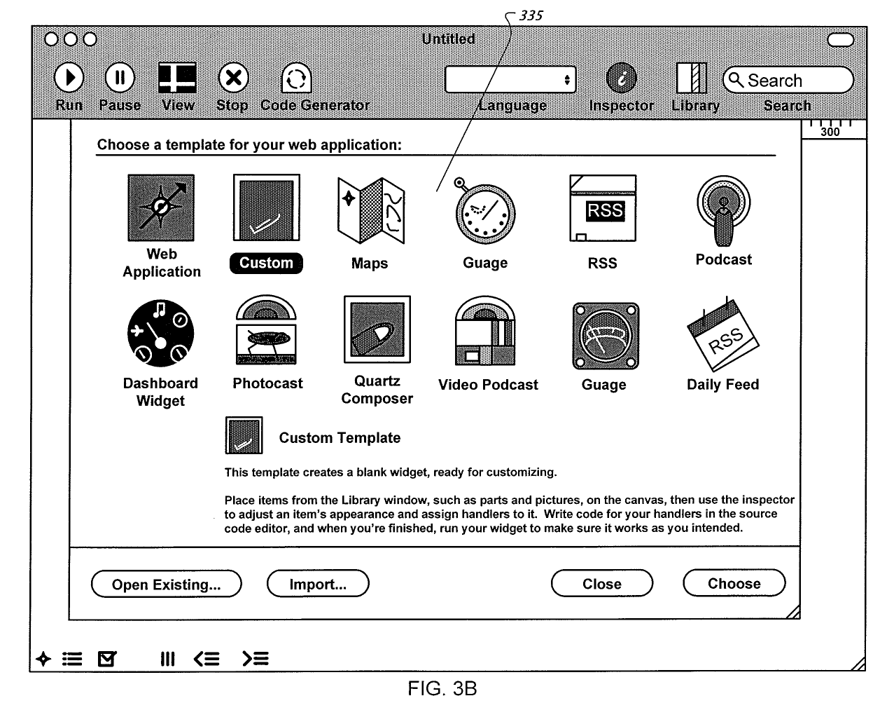

### FIGS. 3A, 4A, 4B, 5A, 5B—Refactoring UI Based on Project Type

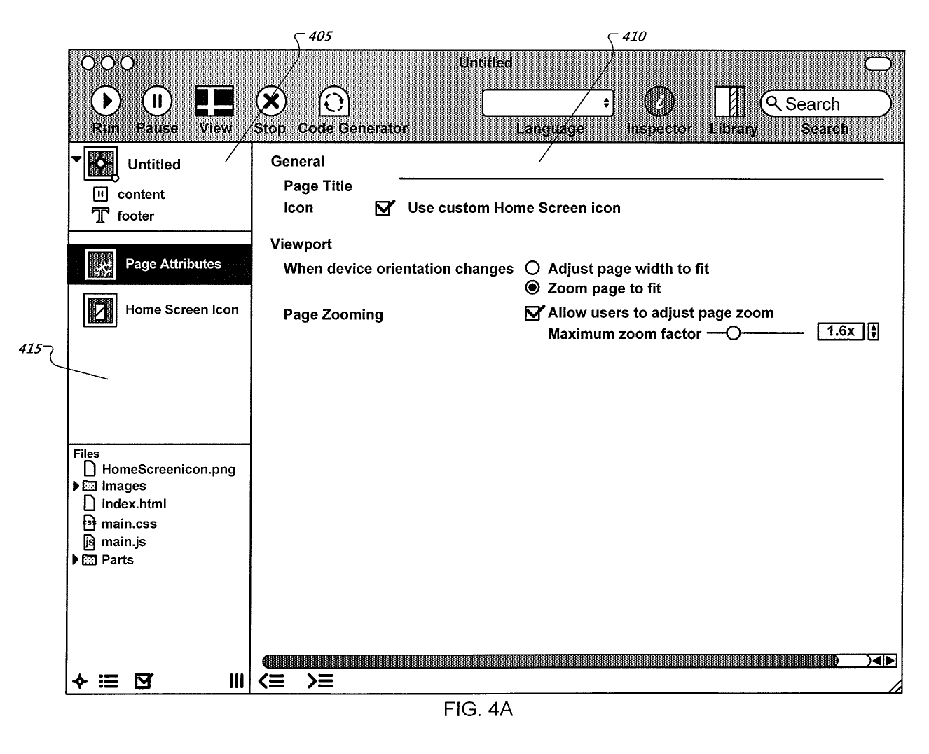

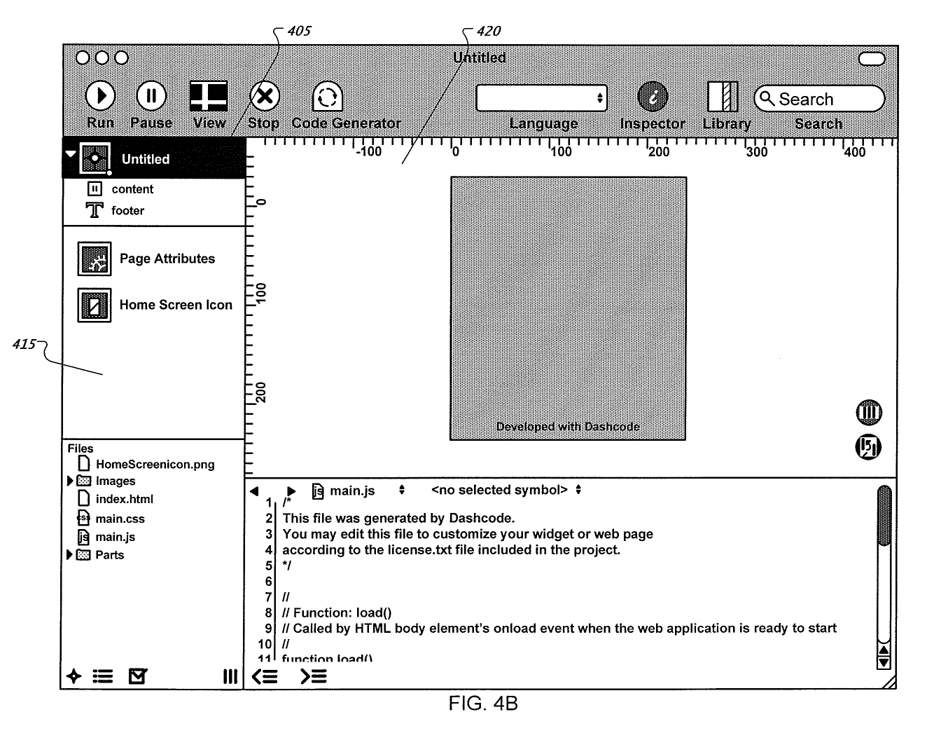

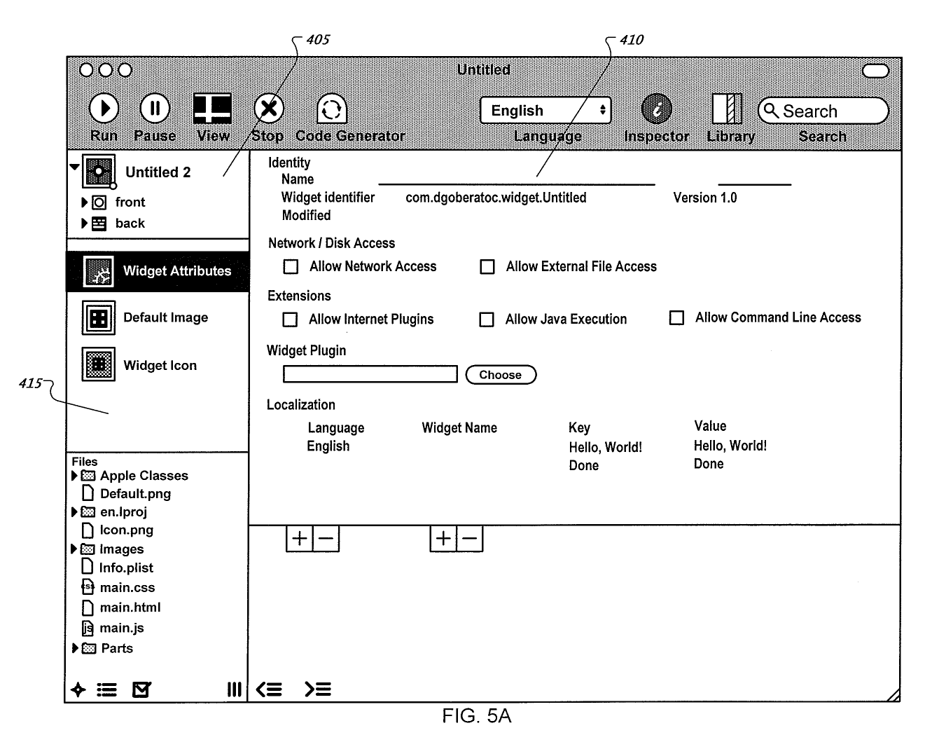

Generally, in FIGS. 3A, 3B, 4A and 4B, aspects of a user interface of a web content creation, editing, test and debug tool are depicted. In the sequel references are made to various embodiments of such a tool by use of the terms “web content editing tool,” “content creation tool,” “content editing tool,” “content creation, editing, test and debug tool,” and variations thereof.

Specifically the figures depict at a high level the features found in a tool such as Dashcode 2.0, available from Apple Inc., and operable on computers that run the Mac OS X operating systems.

In one implementation, FIGS. 3A, 3B, 4A and 4B each represent the refactoring of a user interface used to create web content for different types of final target presentations or documents. In one implementation, the content creation tool uses a set of properties presented as a p-list, to present attributes and controls for the selected type of content.

In FIG. 3A, a project type panel or template chooser panel 325 is used to select a document category out of the available categories, in this implementation, web applications 305 and widgets, 301. In FIG. 3A, the user has selected the web application project type. in this case, the web application templates “custom,” “browser” and “RSS” as shown in the figure at 310, 315 and 320 in panel 335. Information about selected template “Custom” is depicted in information panel 330.

A similar view for the other project type in this implementation, the “widget” type is depicted in FIG. 3B. In FIG. 3B, the templates for a widget type made available via the tool are depicted in template area 335.

Once a template has been chosen, attributes for the project type can then be selected. In FIG. 4A, the attributes available for a web application are shown. In this case, the web application is targeted to a mobile device such as an iPhone and may have settings relating to device orientation and zoom. In other implementations, the target device may differ.

In FIG. 4B, the web application design user interface is shown.

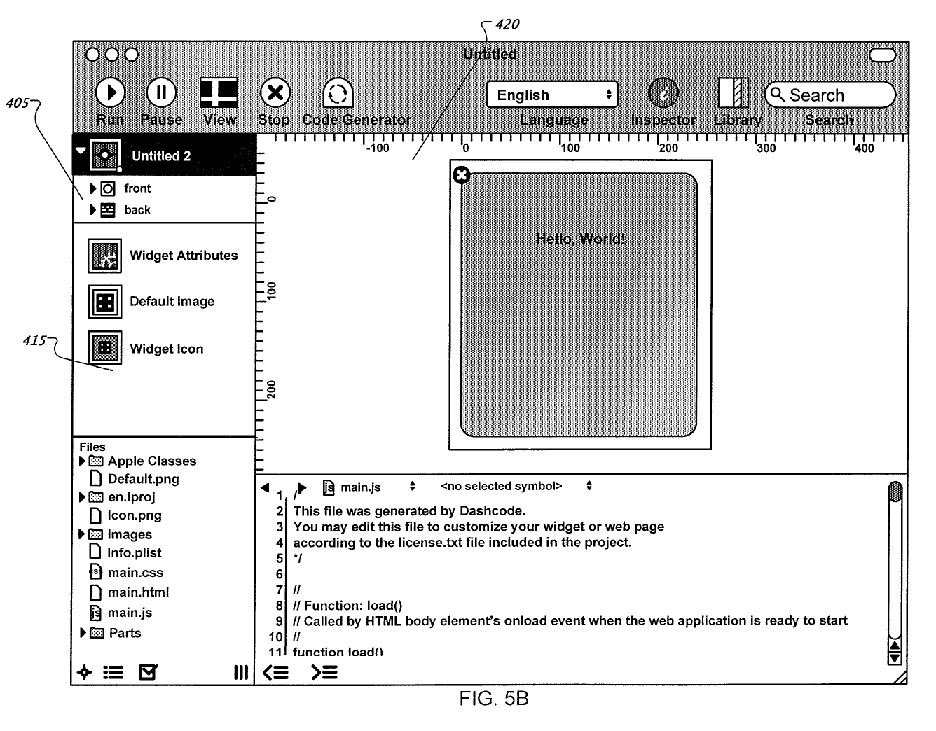

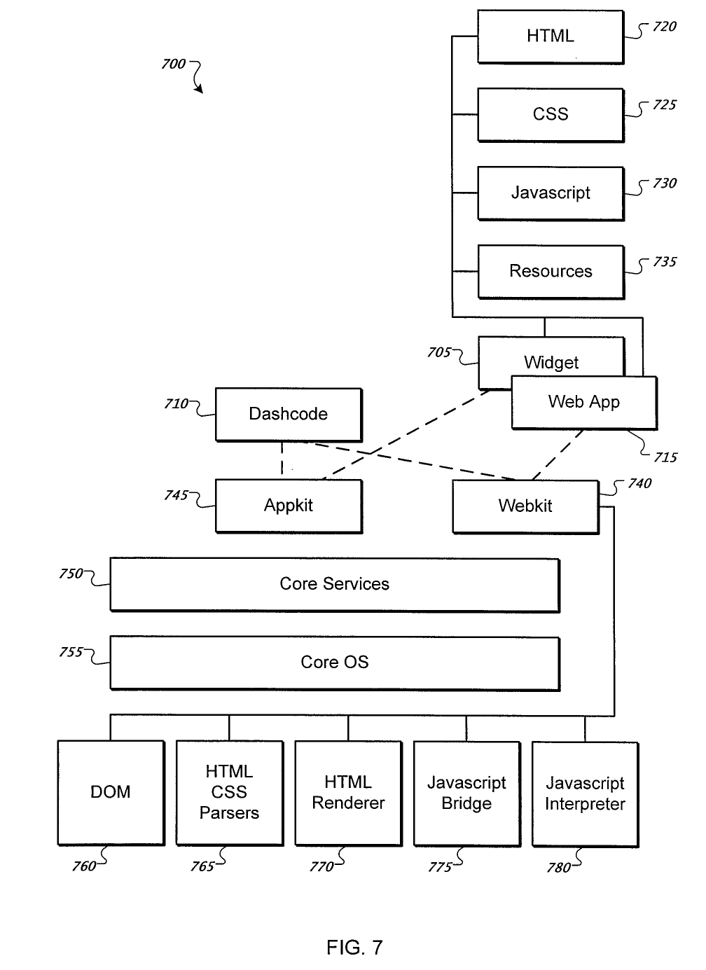

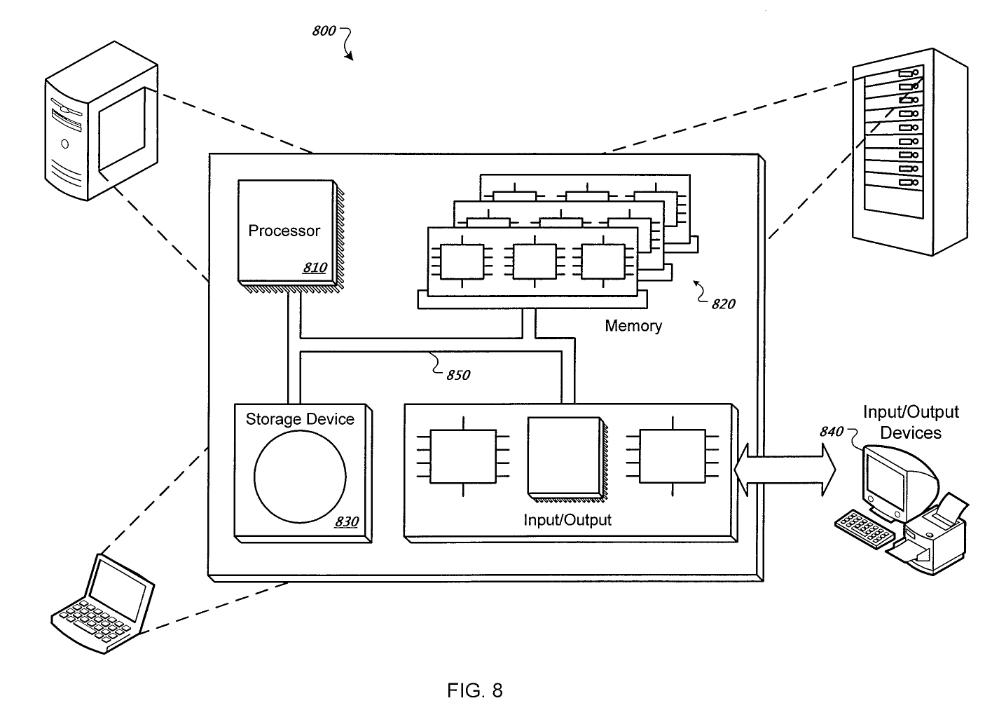

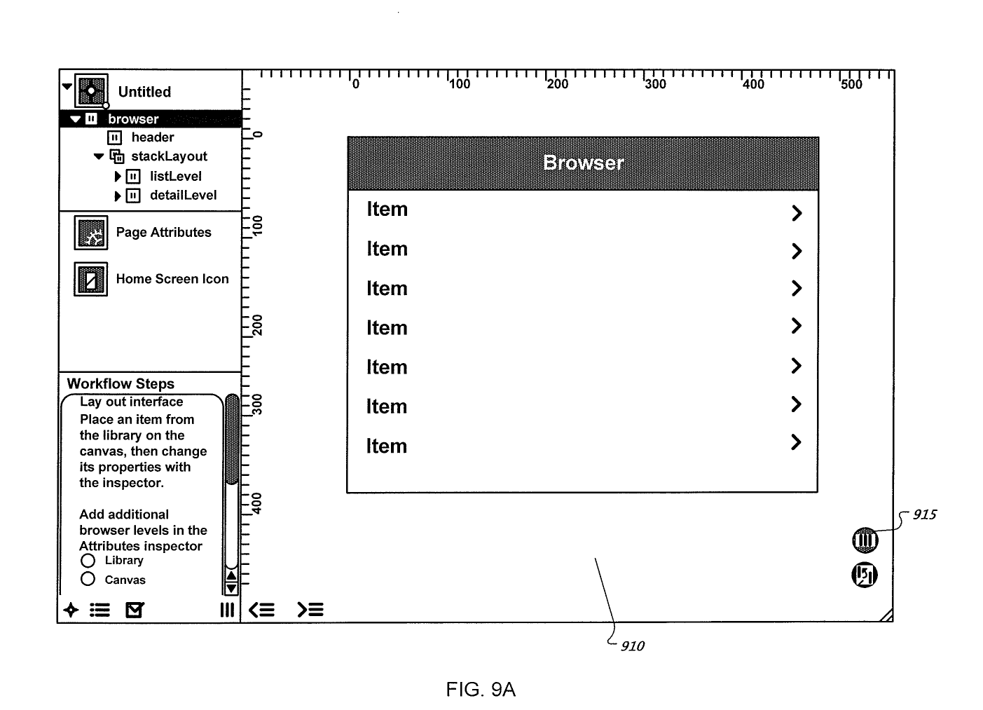

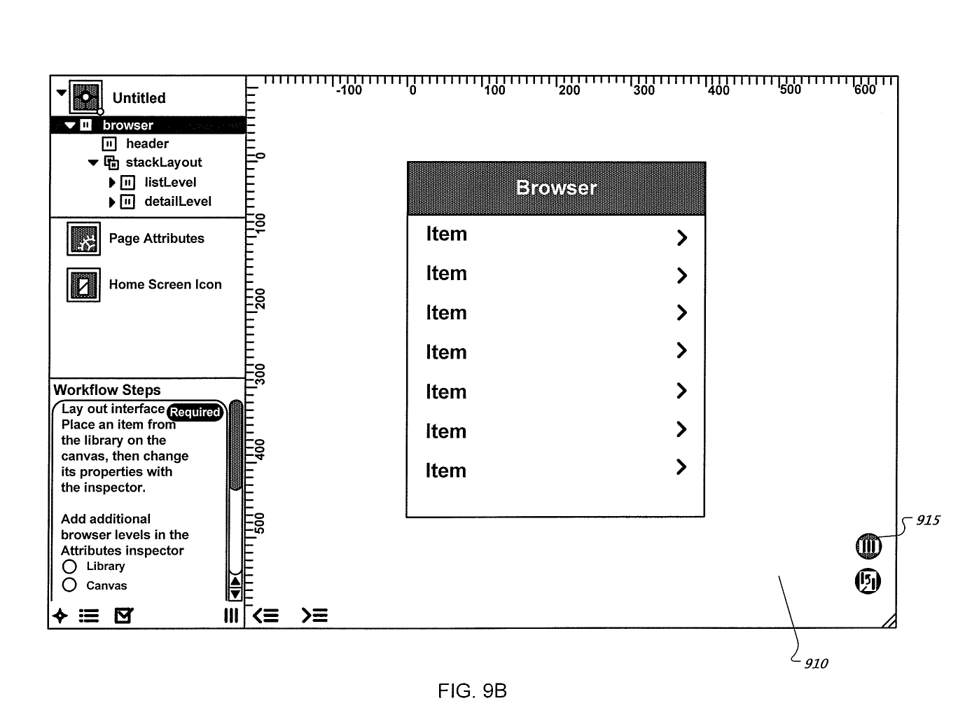

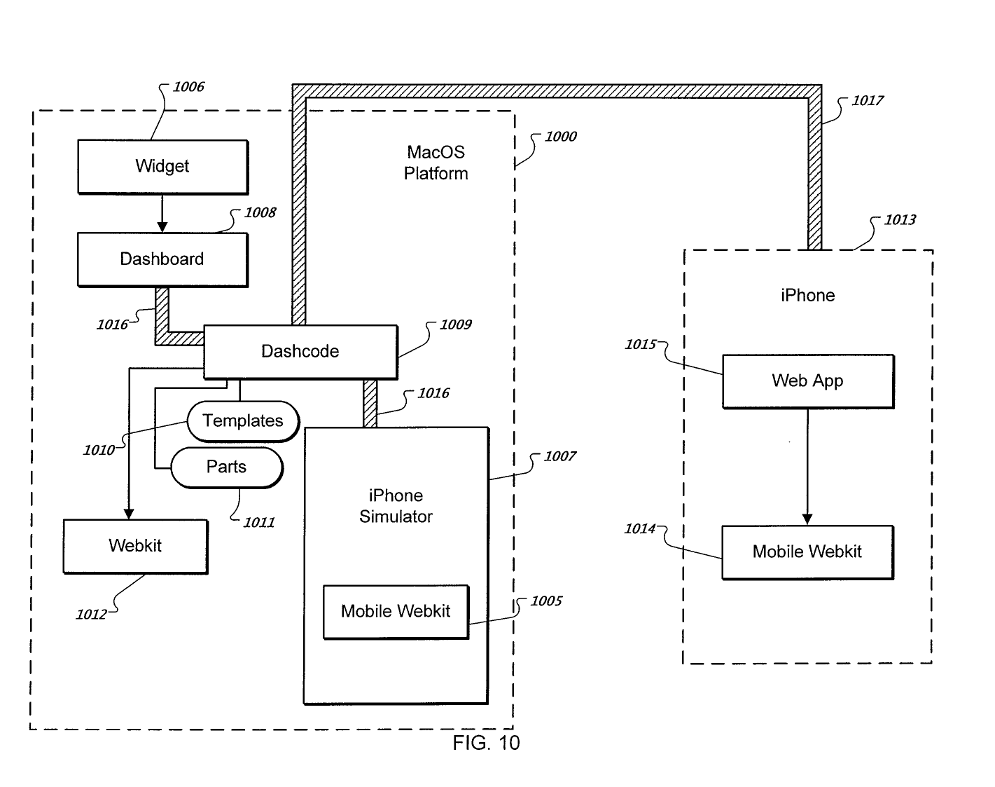

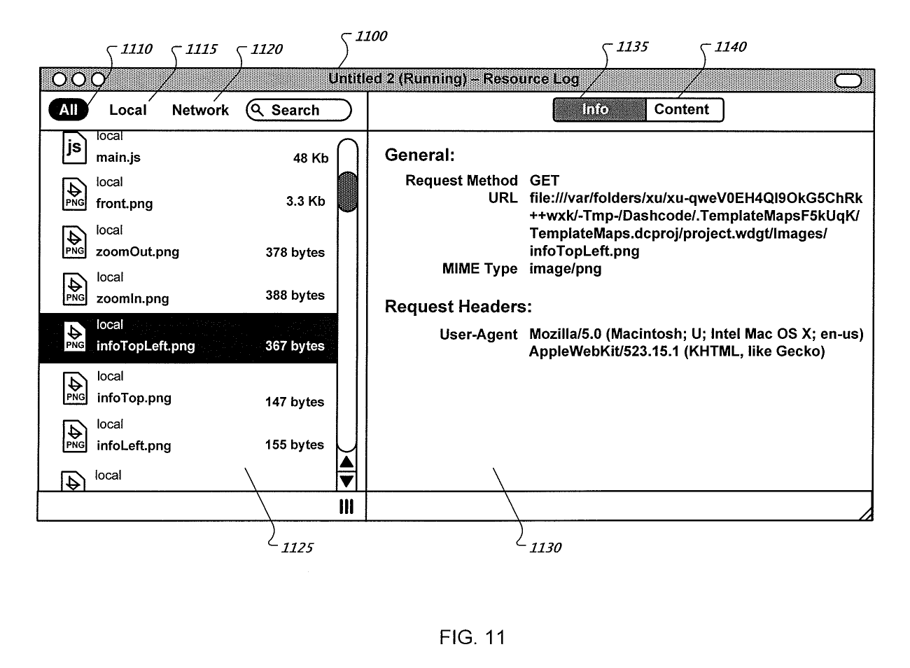

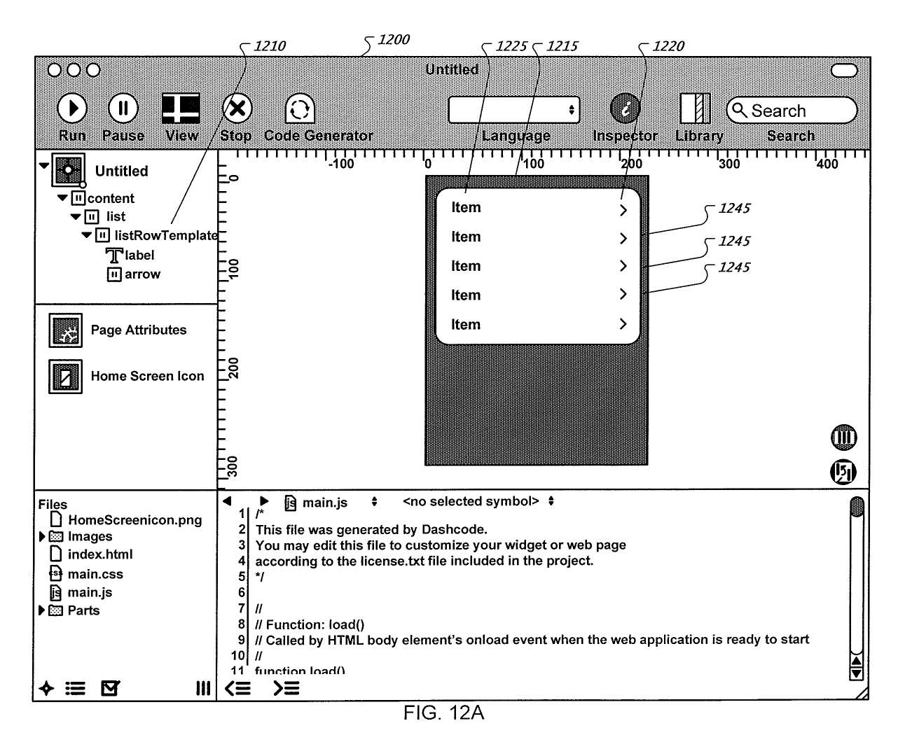

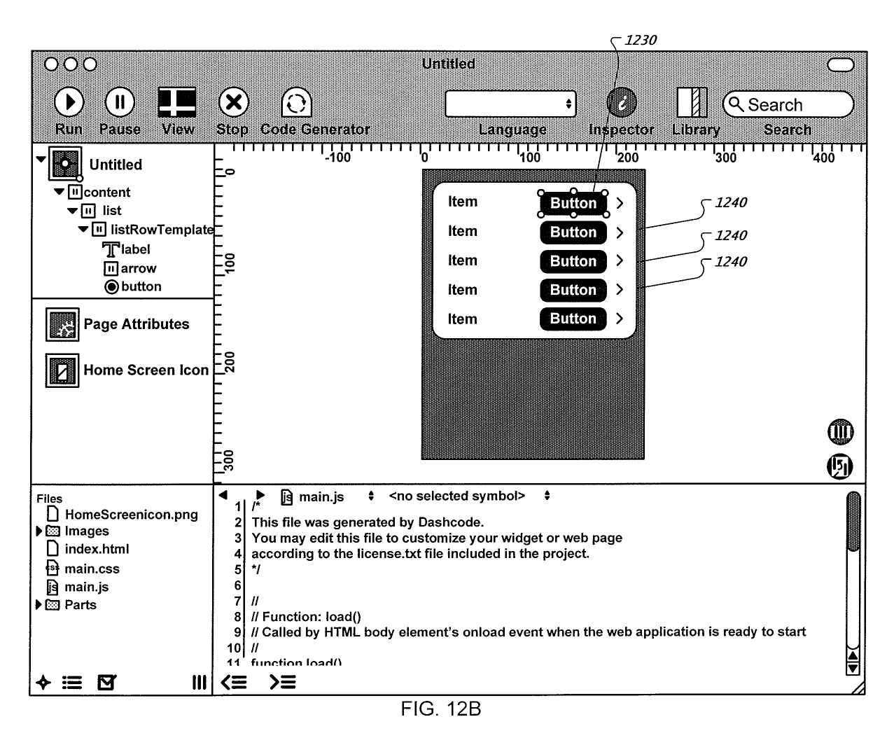

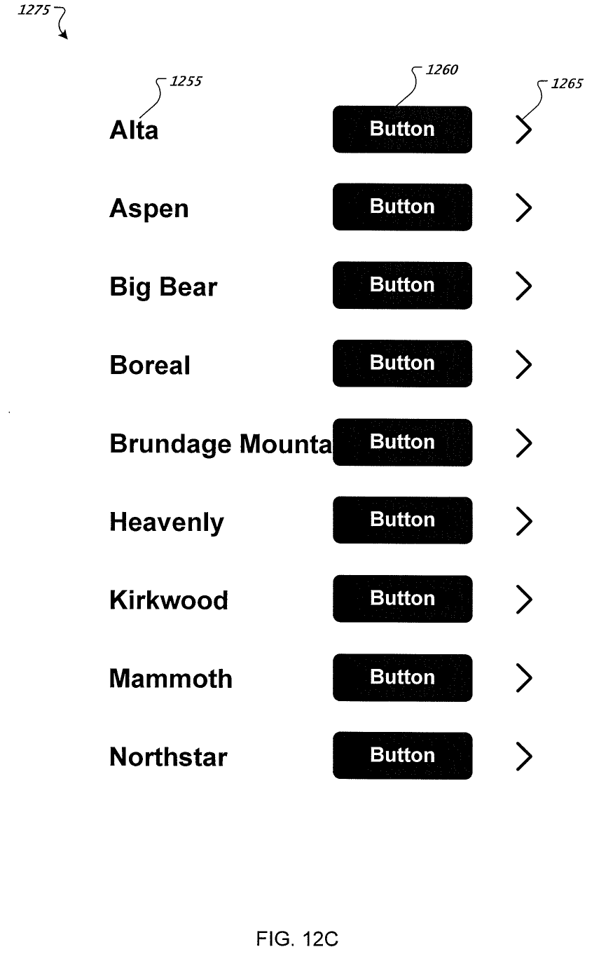

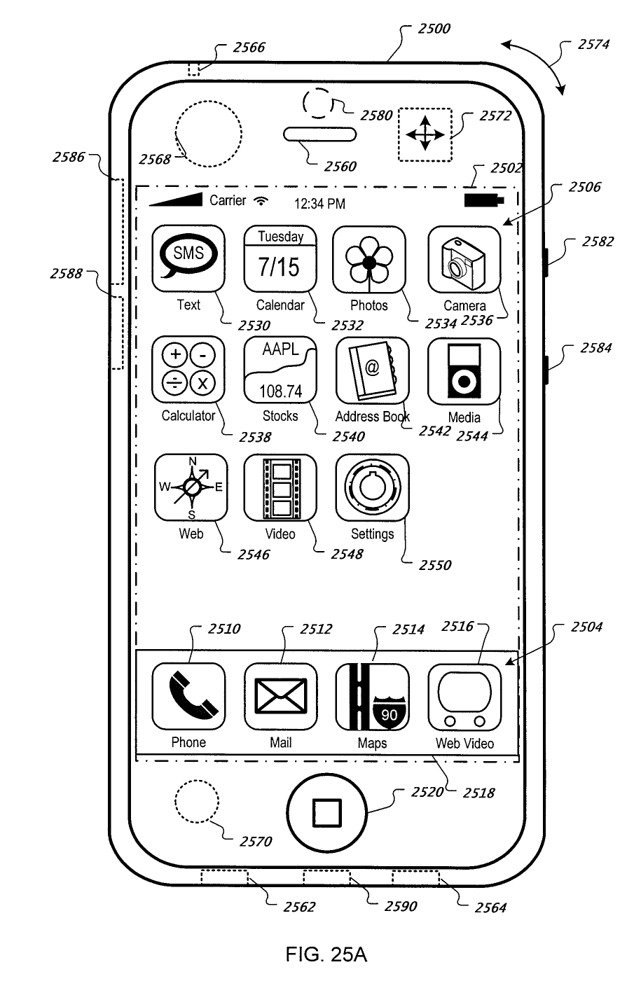

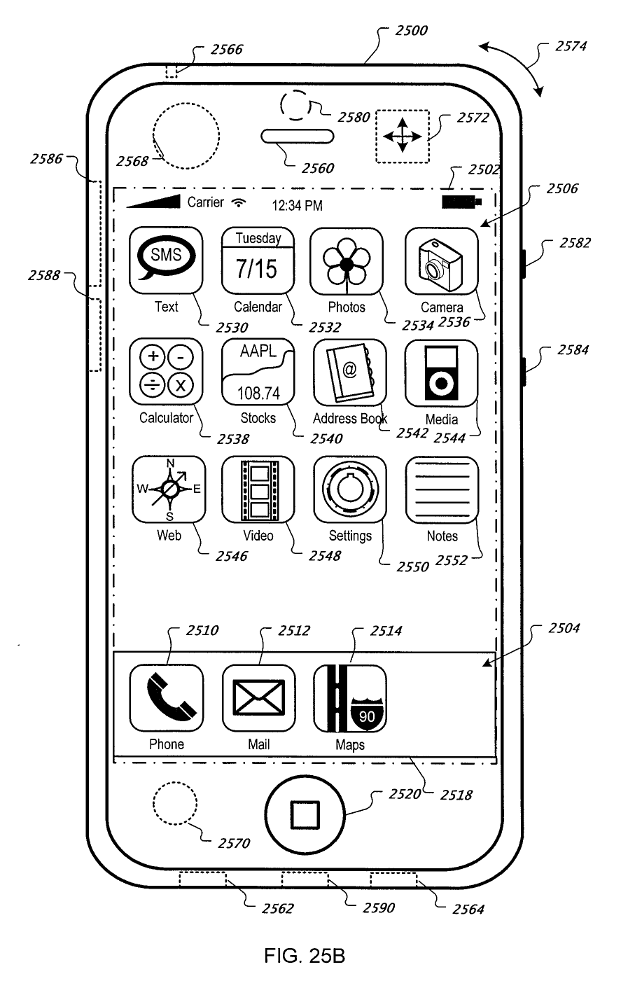

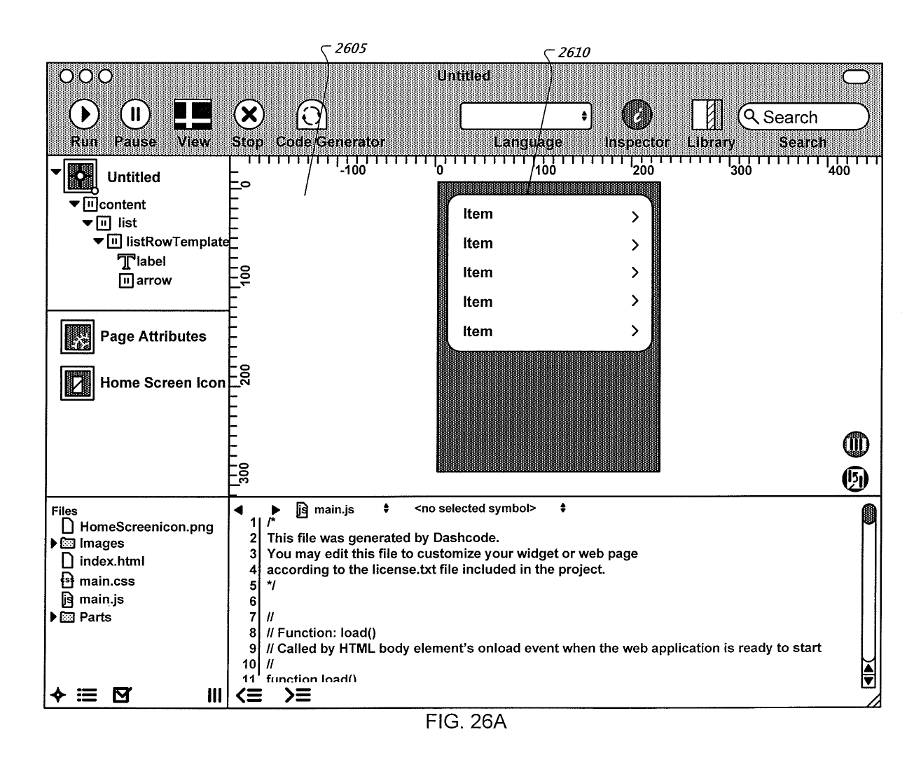

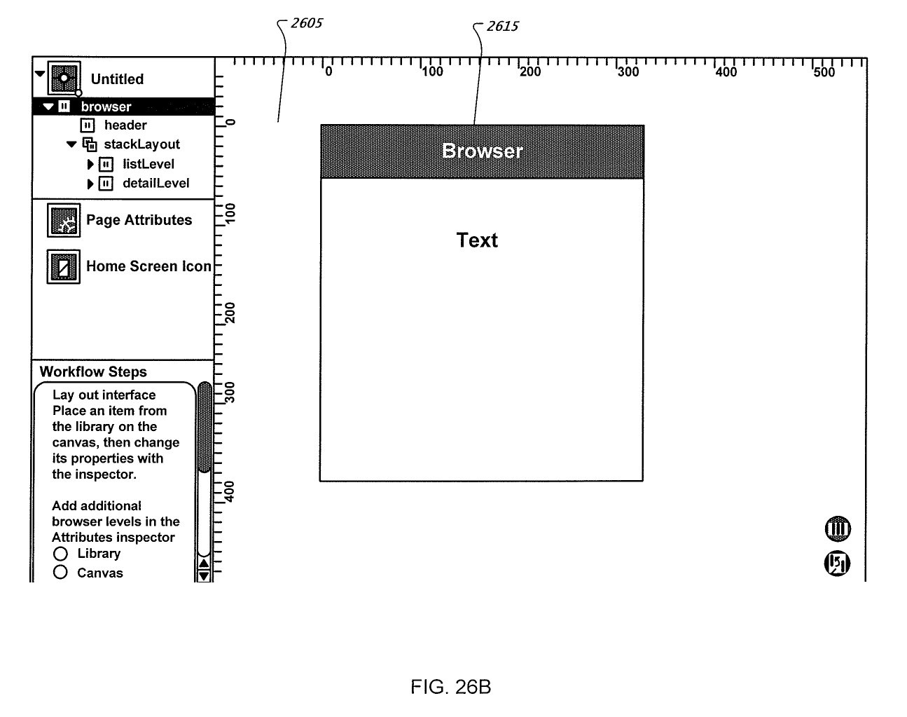

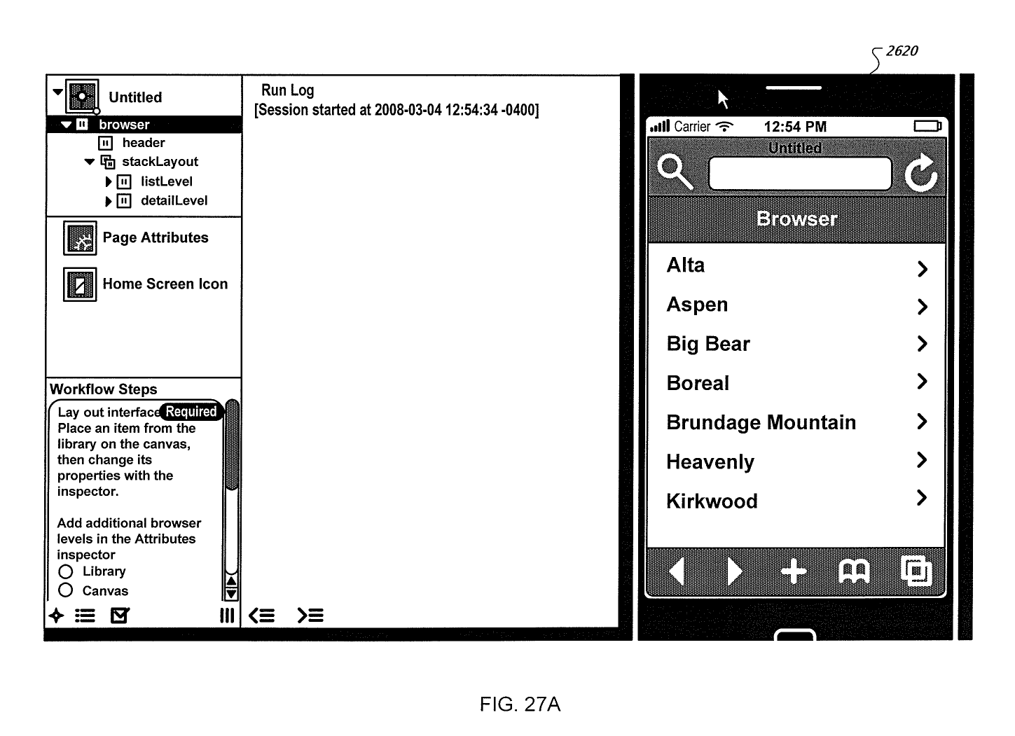

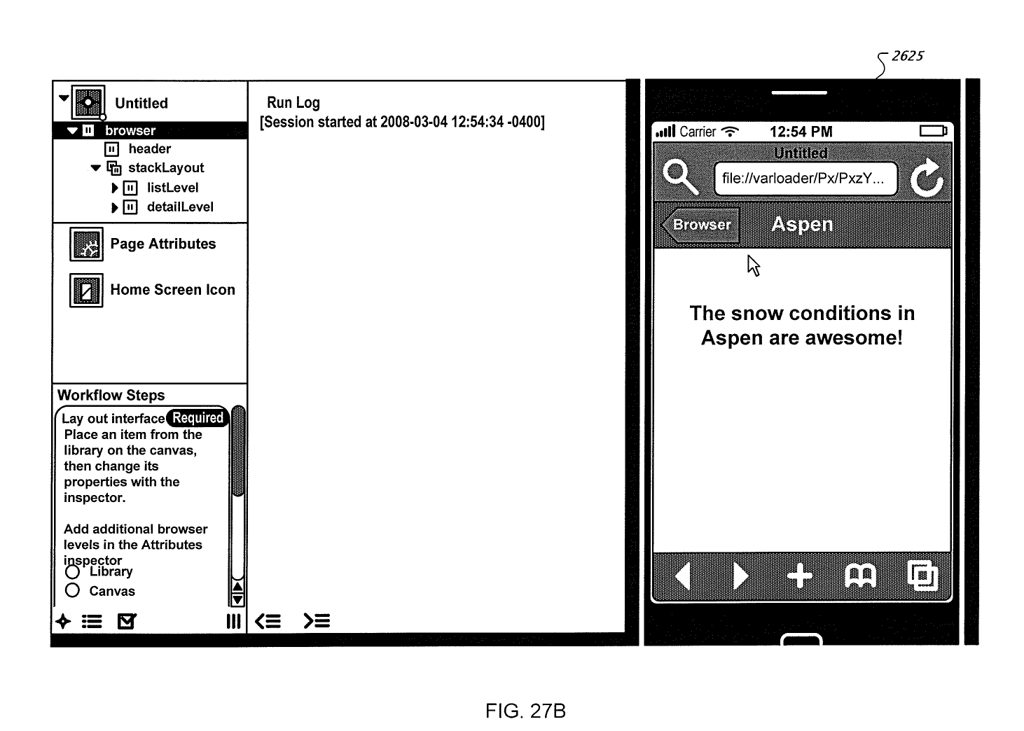

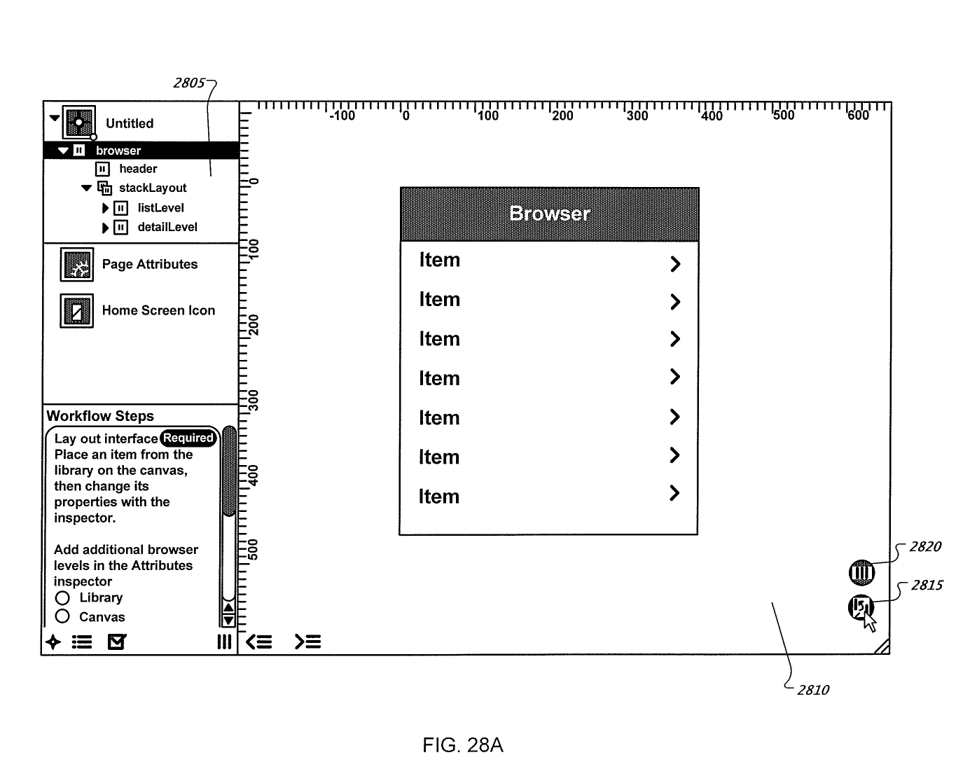

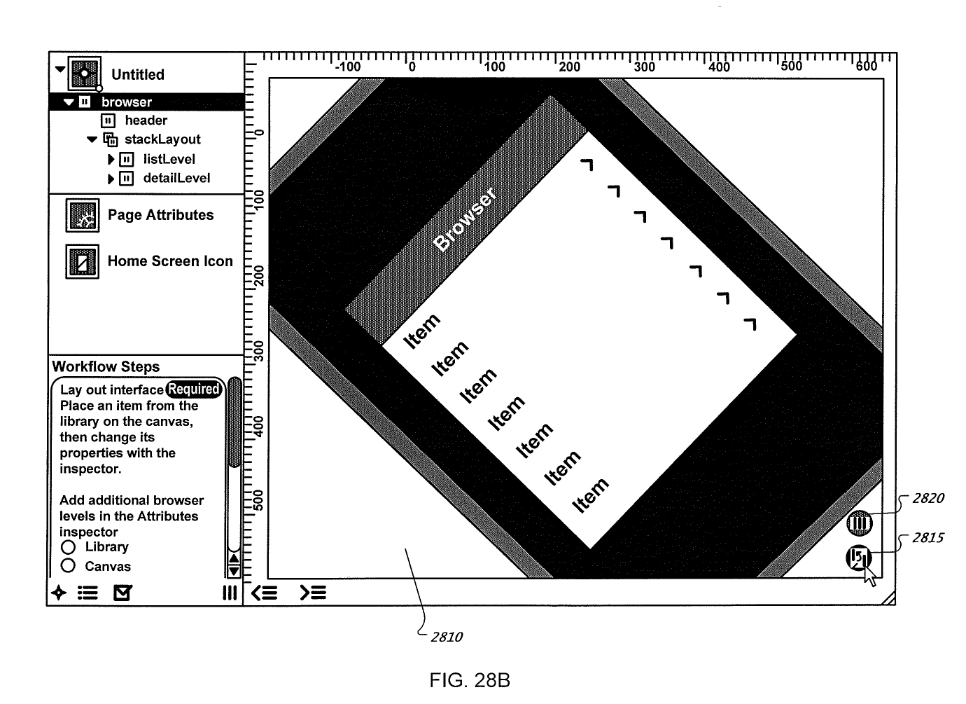

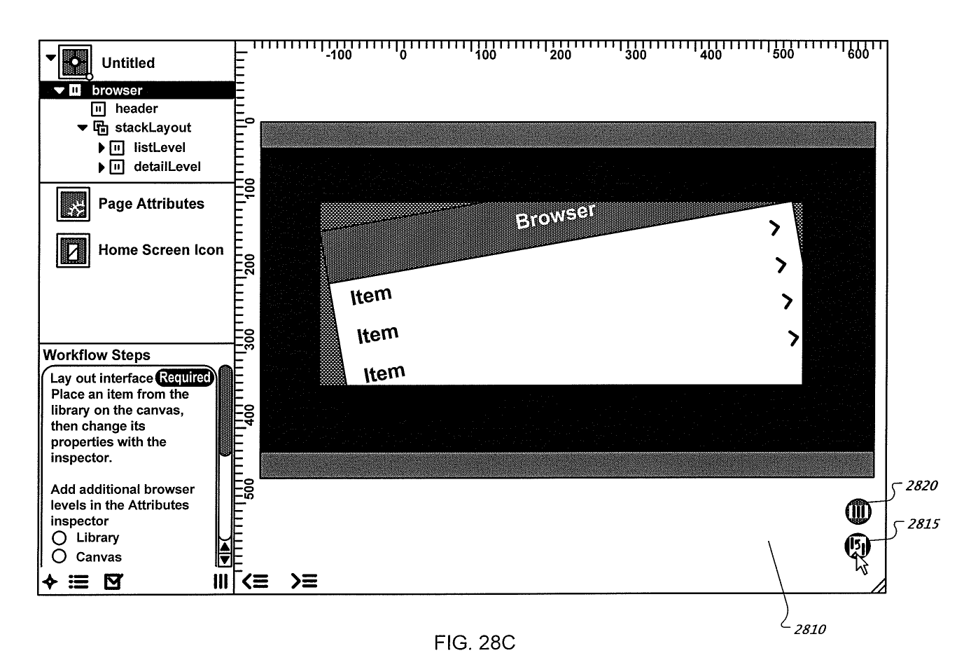

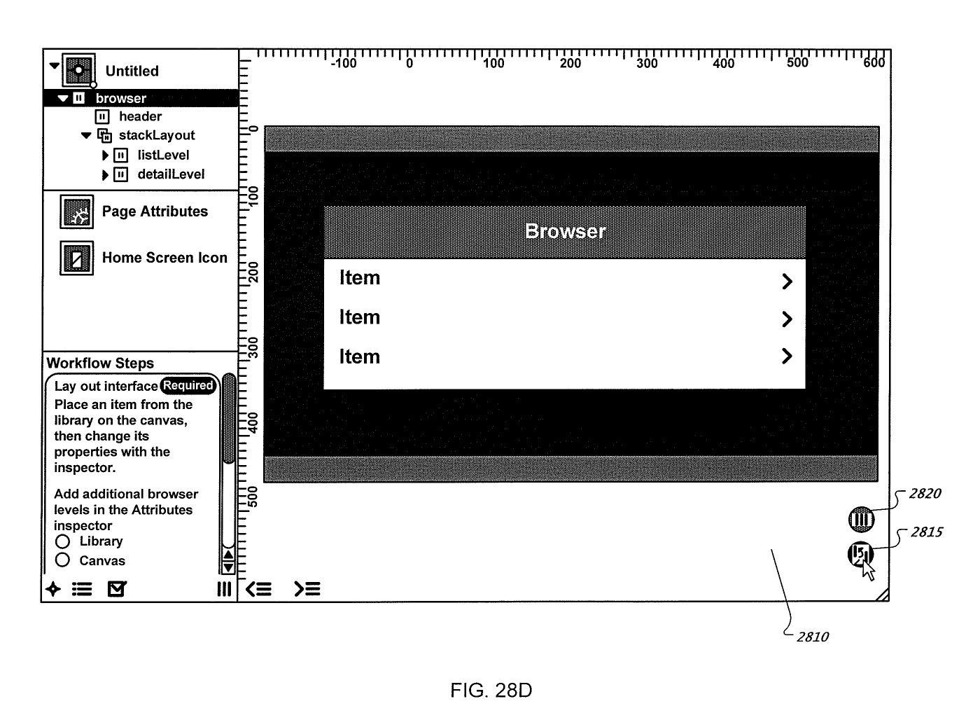

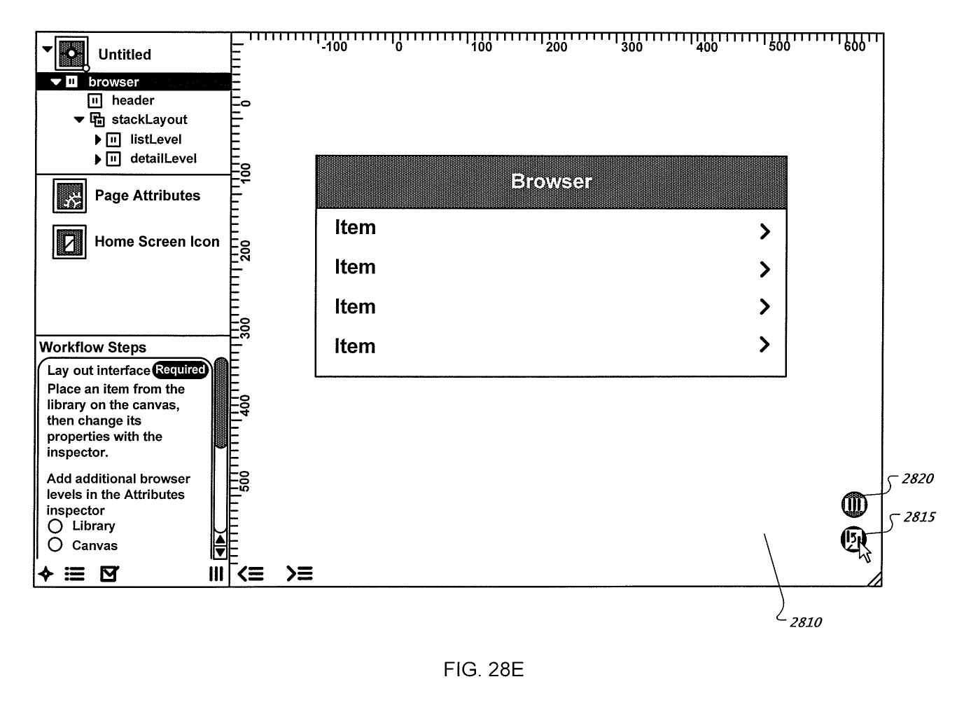

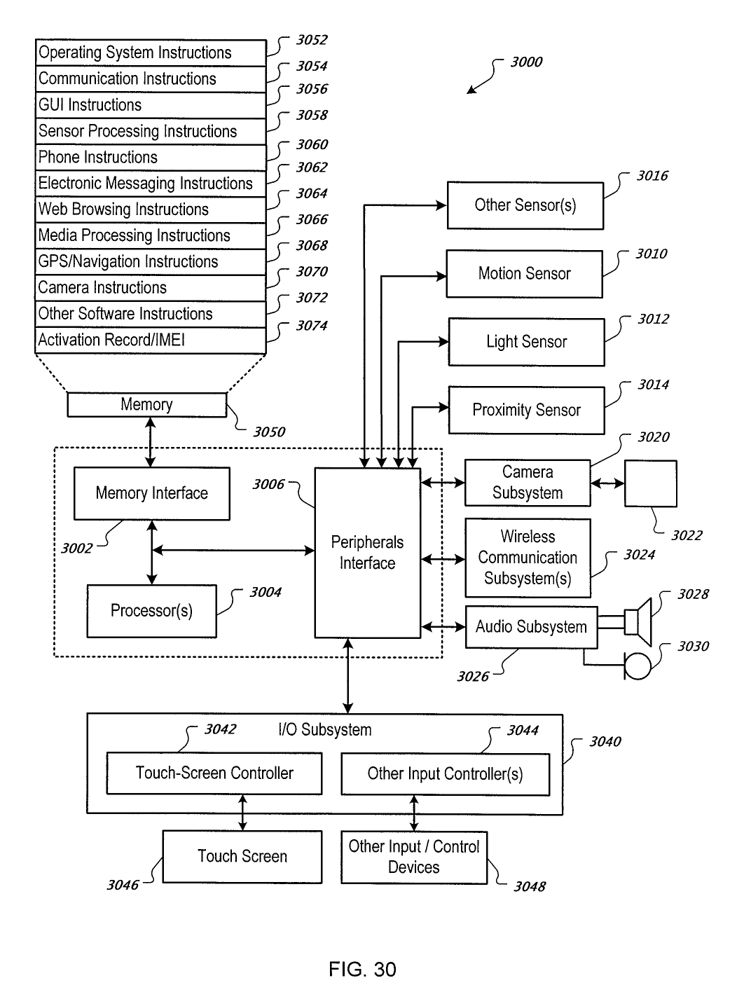

A similar pair of figures is provided for widget design. In FIG. 5A, a set of widget attributes may be selected. As may be seen, these are significantly different from the attributes available for a web application as in FIG. 4A. identifier, access permissions and localization Furthermore, in FIG. 5B, a widget content editing interface is shown. Widget authoring in some embodiments has been discussed in related application Ser. No. 11/145,577 referenced above.

For each specific project type, templates, attributes, library parts, views, icons and other variable elements of the interface can be provided. For example, scaling and rotation are relevant for web applications for a mobile device, whereas they are not for widgets. On the other hand, the concept of a front and back side of a widget are not relevant to a web application.

Deployment behavior may also differ between the two project types. For example, widgets can deploy directly to a Mac OS Dashboard or generate a widget in a directory. In web applications the tool may upload the application directly to a web server or generate a folder with a web page and resources.

As may be appreciated, there may be other document types for which other interface versions and attributes may be presented. For example, an extension of this interface to generalized web pages or other types of content may be provided with modifications to the attributes and user interface as needed.

### FIGS. 1.1-1.8—Dynamic WYSIWYG UI for Editing of a Document With Flow and Static Elements

In an implementation of a content creation interface as depicted in FIGS. 1.1 through 1.8, addition of elements to a document flow is depicted. In one implementation the document comprises web content, that is content created using various web technologies including, for example, a markup language (e.g., HTML, XHTML), Cascading Style Sheets (CSS), JavaScript®, etc.). As is known in the art, elements in the document may be part of a document flow, that is, they may move relative to the boundaries of a view or a page as additional content is added or changed around them; or they may be statically fixed in various ways.

In FIG. 1.1 a box element 110 is added to a document in a document editor or creator. This box may be resized or changed and the underlying markup language and content may then be automatically modified based on user input to reflect the changes as made by the user in this implementation. In FIG. 1.2 a “browser” part is added which includes a fixed Home button 115. This Home button may be specified as a fixed element of the document flow by, for example, its CSS properties. As before, all the underlying code corresponding to the browser part may be added at the same time. In FIG. 1.3, a Back button 120 is added, and moved by the user to a location beneath the home button. The Back button 120 is a movable element of the document flow If the user attempts to move the Back button up further, as in FIG. 1.4, the content creation implementation may automatically reposition the button 120 to a location above the fixed Home button 115, and modify the underlying code, in this implementation, in CSS and HTML, to reflect the new relative position of the Back button. It may be noted that no user modification of the underlying code for the document is necessary to achieve the movement of the Back button 120 “around” the Home button 115.

In FIG. 1.5 the user adds a Gauge element 125 to the document. In one implementation, selection from a predefined library of elements (not shown in the figure) may be performed to add an element such as a Gauge 125. This Gauge element may be moved like the Back button and positioned as shown in FIG. 1.6 In FIG. 1.7, a list element 130 also selected from a library is depicted, and this list element 130 is added below the Gauge element 125. The Gauge element 125 is not fixed and therefore it may be moved up by the content creation tool in this implementation to accommodate the list element 130. If the List element 130 is moved further up by the user, the Gauge element may slide under the List element as shown in FIG. 1.8

Thus this implementation allows a content creator to have a live, dynamic view of a document, implemented in this example by CSS and HTML elements, and to move the visual versions of those elements directly using a user interface without having to actually rewrite the underlying code. Furthermore, the implementation allows the mixture of flow and non-flow elements such as the Home button and the Back button in the same content and may appropriately move flow elements “around” the non-flow elements by altering the CSS appropriately as the user moves them on the interface.

As may be appreciated by one in the art, this technique may in general be applied to any document or content having flowing and non-flowing elements and is not limited merely to web based content. Thus for example, a sheet music composition system, layout editor for CAD, or any other application where user interacts with a visual version of an underlying coded representation are all candidates for this technique of making a dynamic live version of the underlying representation available for manipulation by the user.

FIGS. 2.1-2.7 UI for Insertion of Elements into a Parent Container in a Hierarchical Document

FIGS. 2.1-2.7 depict one specific aspect of an implementation. In web-based content, there may a Document Object Model (DOM) that may describe a hierarchy of containers made up by elements such as, for example, DIV elements. When a new object is introduced onto a visual dynamic representation of the web content, in a web content creation tool, the tool may locate it at one level of the hierarchy. Thus for example, in FIG. 2.1, a basic browser element 205 is depicted. In FIG. 2.2, a new element, Button 210 is added. As Button 210 is added, it is moved off the top of the view by the user (FIG. 2.2). In one implementation, the content editing tool may create a top level sibling to the browser element as showing FIG. 2.3 and add the button 210 as a sibling of the browser element 205. In a similar manner, in FIG. 2.4, a table row 215 is depicted. A rectangle 220 is added as a child of the table cell enclosing it in FIG. 2.5 However, if the user moves the rectangle 220 outside the table cell, as in FIG. 2.6, the rectangle is placed at a different level in the hierarchy and becomes a sibling of the table row 215 in FIG. 2.7 As before the changes on the screen view of the implementation are reflected in the underlying implementation of the document, in this case, in CSS and HTML.

Thus in general the implementation allows movement in a hierarchical document from one level to a parent level by a user movement of a representation over a boundary of the lower level.

### FIGS. 12A-12C—Automatic Replication of Sub-Components and Sub-Structure Based on Editing a Canonical Component

FIG. 12A depicts a list creation process in one example of web application creation in a content creation tool 1200, such as Dashcode 2.0. In this figure, a list 1215 is shown. This may be available as a standardized list part in a library. As indicated in the navigator frame, a list row template 1210 has been selected. In the document view the list 1215 shows the elements of the template, which are the label 1225 and the arrow 1220. It may be noted that those elements are also present in the navigator pane on the left. Template row 1215 is the only row that the user can modify by adding and deleting elements, positioning them, etc. All other rows are grayed out because they are related to the first one and cannot be modified directly. As the item 1215 is edited by a user, the template is modified. This then may cause all the remaining rows in the list, 1245, to be modified in accordance with the modification of the template.

In FIG. 12B, a modification of the template is depicted for the list described above with reference to FIG. 12A. A button element 1230 has been added to the list by the user. As may be seen in the navigator on the left, a button has been also added to the listRowTemplate element, to which the first row of the list in the document view corresponds. The tool automatically then may update all other rows in the list 1240 with the addition of a button in accordance with the addition of the button 1230 to the template. In this implementation the update to other rows or elements occurs very shortly after the update of the template row or element, appearing to the user as virtually immediate.

FIG. 12C shows a runtime view of the document view of FIG. 12B. In this view, a web application with content based on the document design of FIG. 12B is shown running in a window. As may be seen, a list 1275 corresponding to the template and list of FIG. 12B is present with text 1255, button 1260 and arrow 1265 in each row

In general, implementations such as the content creation tool may automatically replicate in an intelligent manner, all the components and subcomponents of a repeated element. One important aspect of this replication is that while elements of each replicated piece may be similar, e.g. each list element may have components such as an icon, a text field, a button, an arrow among other myriad possibilities, their actual identifiers in the underlying document structure, e.g. in a DOM, will be different. That is, elements in the template row have an identifier that must be unique in the scope of the document. Because of this, when creating a cloned or similar element based on the template row or element, these identifiers are stripped out, but the cloned row may need to keep a reference to them in a dictionary. This way, the developer's code may then customize each row individually such as by adding specific text or values to a text field or button, in this example, by accessing the relevant internal elements through this dictionary and inserting data into them. A dictionary call back may be used in each duplicated element to construct the new copy based on the template. At runtime, the template element may be used to perform error checking.

As an example of how the list row template may be used, note that in FIG. 12C, there are 3 elements: “label”, “arrow” and “button”. A use may implement a function called, for example prepareRow(clone) that receives the cloned row. This clone has a “templateElements” attribute with a reference to each element inside it. In that function, the developer may have the following code:

clone.templateElements.label.innerText=“text of the cloned row”

to change the label of the row being processed

A list is only one example of this type of templating and replication of sub elements. In other examples, cells in a grid or even pages in a stacked view may be replicated using this technique of editing a canonical representative and modifying duplicative replicated versions with unique identifiers but a common dictionary of elements. Of course, this is not an exhaustive list of the types of replicated structures for which this technique may be employed. Furthermore, the sub elements of the canonical element, e.g. a button or text or an arrow, may also be various and different and include a myriad of sub elements such as geometrical shapes, text fields, active text, and many others as is known. Furthermore, such templating may be recursively employed in some implementations.

FIGS. 9A and 9B Depict Switching from Pixel Based Scaling to Dimension Based Scaling in One Embodiment; FIGS. 28A-28E Depict Rotation of Content for a Fixed Size Window in an Implementation

FIGS. 9A-B depicts one element of the user interface that includes an implementation to visualize scaling of the view in the content creation tool. In FIG. 9A, the view is a pixel to pixel analog of the view on the mobile device. Activating button 915 begins a process of the tool simulating how the document may appear on a mobile device like an iPhone Button 915 causes a resealing to a 1:1 dimensionally accurate analog of the view on the mobile device, as shown in FIG. 9B. This may be necessary for an accurate visualization of a web application executing on a mobile device such as an iPhone because pixel sizes on a mobile device differ from the pixel sizes on a development platform.

FIGS. 28A-28D depict the visual appearance of a web application in a simulation of a rotation of a mobile device. Thus, the user selection of button 2815 in FIG. 28A causes the content creation tool to display a rotation to show the user what the content which starts in a vertical configuration in 28A will appear when rotated to the configuration in 28D. FIGS. 28B and 28C depict an animation indicating what a user of a mobile device may see when a rotation of the view occurs on the device. This may e.g. be caused by an accelerometer based detection of a change of orientation on a device such as an iPhone.

### FIGS. 26A and 26B Depict a Stacked Layout in a Document Creation Process in an Implementation.

FIGS. 26A and 26B depict the stacked layout view in a web application development scenario. In FIG. 26A, a list element 2610 in a stack of views is created, termed a list view. In FIG. 26B, a detail level, a text view, is created. It may be noted that the navigator panel on the left of document panel 2605, the list view and detail view are shown as siblings.

To switch between the two views, which in the underlying code are sections of a single document, it is only necessary to select the appropriate icon in the navigator. In existing art, it may be necessary to manually edit the document code to make only one of the levels visible while hiding the other.

When the content produced in FIGS. 26A and 26B is viewed, the appearance on the mobile device is simulated as in FIG. 27A and FIG. 27B at 2620 and 2625.

In other implementations, other types of hierarchical views may be presented in a similar or analogous manner using a representation of a tree. Clicking or selecting a single or a set of nodes in the navigation tree could then produce on a viewing panel a view including only those elements of the hierarchical structure that are selected.

FIG. 11 is a Diagram of the User Interface of a Tool to Record and View Local and Network Resources used by a Web Application or a Widget.

FIG. 11 depicts a monitoring element of an application to create web applications and widgets such as Dashcode. Each web application or widget may access resources or consume resources. These may include system resources such as disk, system memory, or network bandwidth; alternatively the web application or widget may access specific data locations on the network such as a URI or networked file. When a user of the content creation application runs a widget or web application in a debug mode, the application may bring up a resource logging interface for that application. A sample screen from such a resource logging interface is depicted at a logical level in the figure. The output of the resource logger may be unfiltered as indicated by selecting the “All” button 1110, filtered to include only local resources by selecting the “Local” button 1115, or only resources from the network by selecting “Network” button 1120. Clicking on or otherwise selecting a specific item in the list 1125 any column brings up a detail pane 1130 that provides detail on the item selected. The detail pane may switch between information about the content as shown in FIG. 11, or the content itself, e.g. a bitmap or text, based on the info-content selectors 1135-1140.

In addition to the resource logger interface, the content creation and debug tool may also provide graphical representations of memory, CPU and network use via representations such as a needle-and-dial or pie-chart with different colors to indicate CPU usage or used v/s available memory, respectively.

It is to be noted that the resource log and performance parameters are specific to the particular web application or widget. Thus a user of the content creation application and debug system may see exactly what level and type of resource use is being required for a specific application or widget.

### FIG. 10 is a Diagram of the Software Architecture of a Web Application and Widget Authoring System.

FIG. 10 depicts a software architecture of a system implementing the content editing and runtime environment described. Content creation, test and debug tool 1009 such as e.g. Dashcode 2.0 executes on platform 1000 such as a Mac OS X system. Dashcode uses Webkit, 1012, described below, to perform various functions including rendering, transforms, animation, etc. Daschcode may use templates and parts 1010 and 1011. Furthermore, widgets 1006 created with Dashcode may be used in Dashboard 1008. Web applications created in Dashcode may be run for test and debug on a mobile device simulator such as iPhone simulator 1007 which may incorporate a mobile version of Webkit or similar framework, 1005. Dashcode may also run web applications for test and debug on an actual mobile device such as iPhone 1013 over a USB or other network connection, including a wireless connection, accessed at a software level as a socket 1017 in one implementation, and the web application may execute on mobile device 1013 on a mobile webkit instance 1014.

It should be noted that the web apps running in simulator 1005 and on phone 1013 or device 1013 may have debugging plugins to allow Dashcode developers to debug, instrument and monitor such applications, using technologies such as gdb, inspector, instruments and others.

### FIG. 7 is an Example Software Stack for Implementing the Features and Processes Described Herein.

FIG. 7 is a screen shot of example software stack 700 for implementing a content creation, editing, and debug tool such as Dashcode 2.0 for widgets and web applications. The software stack 700 is based on the Mac OS® software stack. It should be noted, however, that any software stack can be used to implement the features and processes described in reference to FIGS. 1-6.

The software stack 700 can include an application layer and operating system layers. In this Mac OS® example, the application layer can include Dashcode 2.0 710, Widgets 705, or Web Applications 715. In some embodiments Widgets may live in a separate Dashboard layer. The Dashcode 2.0 application may include code to facilitate functionality such as widget creation, web application creation, WYSIWYG editing of web content, debug and test of web content, among others.

Web application or widget code can include HTML 720, CSS 725, JavaScript® 730 and other resources 735. CSS is a stylesheet language used to describe the presentation of a document written in a markup language (e.g., style web pages written in HTML, XHTML). CSS may be used by authors and readers of web content to define colors, fonts, layout, and other aspects of document presentation. JavaScript® is a scripting language which may be used to write functions that are embedded in or included from HTML pages and interact with a Document Object Model (DOM) of the page.

In some implementations, a web application 715, a widget 705 or web content creation and debug tool such as Dashcode 2.0, 710, in the application layer uses WebKit® services 740. WebKit® 740 is an application framework included, in one implementation, with Mac OS X. The framework allows third party developers to easily include web functionality in custom applications. WebKit® includes an Objective-C Application Programming Interface (API) that provides the capability to interact with a web server, retrieve and render web pages, download files, and manage plug-ins. WebKit® also includes content parsers (e.g., HTML, CSS parser 765), renderer 770, a JavaScript® bridge 775 (e.g., for synchronizing between a web browser and Java applets), a JavaScript® engine (interpreter) 780 and a DOM 760. The WebKit® can use services provided by Core Services 750, which provide basic low level services. The Core Services can request services directly from the Core OS 755 (e.g., Darwin/Unix).

The software stack 700 provides the software components to create widgets, web applications, debug and test them, and the various features and processes described above. Other software stacks and architectures are possible, including architectures having more or fewer layers, different layers or no layers. Specifically, for one example, the services provided by WebKit may be provided directly by the Operating system, or incorporated into the content creation, debug and test application in other embodiments, or be otherwise provided by a disparate set of libraries. Many other variations of the depicted architecture are possible.

### FIG. 8 is an Example System for Implementing the Features and Processes Described Herein.

FIG. 8 is a screen shot of example system 800 for implementing the features and processes described in reference to FIGS. 1-7. The system 800 may host the software stack 700, described in reference to FIG. 7. The system 800 includes a processor 810, a memory 820, a storage device 830, and an input/output device 840. Each of the components 810, 820, 830, and 840 are interconnected using a system bus 850. The processor 810 is capable of processing instructions for execution within the system 800. In some implementations, the processor 810 is a single-threaded processor. In other implementations, the processor 810 is a multi-threaded processor or multi-core processor. The processor 810 is capable of processing instructions stored in the memory 820 or on the storage device 830 to display graphical information for a user interface on the input/output device 840.

The memory 820 stores information within the system 800. In some implementations, the memory 820 is a computer-readable medium. In other implementations, the memory 820 is a volatile memory unit. In yet other implementations, the memory 820 is a non-volatile memory unit.

The storage device 830 is capable of providing mass storage for the system 800. In some implementations, the storage device 830 is a computer-readable medium. In various different implementations, the storage device 830 may be a floppy disk device, a hard disk device, an optical disk device, or a tape device.

The input/output device 840 provides input/output operations for the system 800. In some implementations, the input/output device 840 includes a keyboard and/or pointing device. In other implementations, the input/output device 840 includes a display unit for displaying graphical user interfaces.

In some embodiments the system 800 may be an Apple computer, such as a Mac Pro, MacBook Pro, or other Apple computer running Mac OS. In other embodiments the system may be a Unix system, a Windows system, or other system as is known.

FIGS. 25A and 25B is a User Interface for Mobile Device that can Implement the Invention.

### FIG. 30 is a Hardware Architecture of the Mobile Device of FIGS. 25A & 25B for Implementing the Invention.

In some implementations, the mobile device 2500 can implement multiple device functionalities, such as a telephony device, as indicated by a Phone object 2510; an e-mail device, as indicated by the Mail object 2512; a map devices, as indicated by the Maps object 2514; a Wi-Fi base station device (not shown); and a network video transmission and display device, as indicated by the Web Video object 2516. In some implementations, particular display objects 2504, e.g., the Phone object 2510, the Mail object 2512, the Maps object 2514, and the Web Video object 2516, can be displayed in a menu bar 2518. In some implementations, device functionalities can be accessed from a top-level graphical user interface, such as the graphical user interface illustrated in FIG. 25A. Touching one of the objects 2510, 2512, 2514, or 2516 can, for example, invoke a corresponding functionality.

In some implementations, the mobile device 2500 can implement a network distribution functionality. For example, the functionality can enable the user to take the mobile device 2500 and provide access to its associated network while traveling. In particular, the mobile device 2500 can extend Internet access (e.g., Wi-Fi) to other wireless devices in the vicinity. For example, mobile device 2500 can be configured as a base station for one or more devices. As such, mobile device 2500 can grant or deny network access to other wireless devices.

In some implementations, upon invocation of a device functionality, the graphical user interface of the mobile device 2500 changes, or is augmented or replaced with another user interface or user interface elements, to facilitate user access to particular functions associated with the corresponding device functionality. For example, in response to a user touching the Phone object 2510, the graphical user interface of the touch-sensitive display 2502 may present display objects related to various phone functions; likewise, touching of the Mail object 2512 may cause the graphical user interface to present display objects related to various e-mail functions; touching the Maps object 2514 may cause the graphical user interface to present display objects related to various maps functions; and touching the Web Video object 2516 may cause the graphical user interface to present display objects related to various web video functions.

In some implementations, the top-level graphical user interface environment or state of FIG. 25A can be restored by pressing a button 2520 located near the bottom of the mobile device 2500. In some implementations, each corresponding device functionality may have corresponding “home” display objects displayed on the touch-sensitive display 2502, and the graphical user interface environment of FIG. 25A can be restored by pressing the “home” display object.

In some implementations, the top-level graphical user interface can include additional display objects 2506, such as a short messaging service (SMS) object 2530, a Calendar object 2532, a Photos object 2534, a Camera object 2536, a Calculator object 2538, a Stocks object 2540, a Address Book object 2542, a Media object 2544, a Web object 2546, a Video object 2548, a Settings object 2550, and a Notes object (not shown). Touching the SMS display object 2530 can, for example, invoke an SMS messaging environment and supporting functionality; likewise, each selection of a display object 2532, 2534, 2536, 2538, 2540, 2542, 2544, 2546, 2548, and 2550 can invoke a corresponding object environment and functionality.

Additional and/or different display objects can also be displayed in the graphical user interface of FIG. 25A. For example, if the device 2500 is functioning as a base station for other devices, one or more “connection” objects may appear in the graphical user interface to indicate the connection. In some implementations, the display objects 2506 can be configured by a user, e.g., a user may specify which display objects 2506 are displayed, and/or may download additional applications or other software that provides other functionalities and corresponding display objects.

In some implementations, the mobile device 2500 can include one or more input/output (I/O) devices and/or sensor devices. For example, a speaker 2560 and a microphone 2562 can be included to facilitate voice-enabled functionalities, such as phone and voice mail functions. In some implementations, an up/down button 2584 for volume control of the speaker 2560 and the microphone 2562 can be included. The mobile device 2500 can also include an on/off button 2582 for a ring indicator of incoming phone calls. In some implementations, a loud speaker 2564 can be included to facilitate hands-free voice functionalities, such as speaker phone functions. An audio jack 2566 can also be included for use of headphones and/or a microphone.

In some implementations, a proximity sensor 2568 can be included to facilitate the detection of the user positioning the mobile device 2500 proximate to the user's ear and, in response, to disengage the touch-sensitive display 2502 to prevent accidental function invocations. In some implementations, the touch-sensitive display 2502 can be turned off to conserve additional power when the mobile device 2500 is proximate to the user's ear.

Other sensors can also be used. For example, in some implementations, an ambient light sensor 2570 can be utilized to facilitate adjusting the brightness of the touch-sensitive display 2502. In some implementations, an accelerometer 2572 can be utilized to detect movement of the mobile device 2500, as indicated by the directional arrow 2574. Accordingly, display objects and/or media can be presented according to a detected orientation, e.g., portrait or landscape. In some implementations, the mobile device 2500 may include circuitry and sensors for supporting a location determining capability, such as that provided by the global positioning system (GPS) or other positioning systems (e.g., systems using Wi-Fi access points, television signals, cellular grids, Uniform Resource Locators (URLs)). In some implementations, a positioning system (e.g., a GPS receiver) can be integrated into the mobile device 2500 or provided as a separate device that can be coupled to the mobile device 2500 through an interface (e.g., port device 2590) to provide access to location-based services.

In some implementations, a port device 2590, e.g., a Universal Serial Bus (USB) port, or a docking port, or some other wired port connection, can be included. The port device 2590 can, for example, be utilized to establish a wired connection to other computing devices, such as other communication devices 2500, network access devices, a personal computer, a printer, a display screen, or other processing devices capable of receiving and/or transmitting data. In some implementations, the port device 2590 allows the mobile device 2500 to synchronize with a host device using one or more protocols, such as, for example, the TCP/IP, HTTP, UDP and any other known protocol.

The mobile device 2500 can also include a camera lens and sensor 2580. In some implementations, the camera lens and sensor 2580 can be located on the back surface of the mobile device 2500. The camera can capture still images and/or video.

The mobile device 2500 can also include one or more wireless communication subsystems, such as an 802.11b/g communication device 2586, and/or a Bluetooth™ communication device 2588. Other communication protocols can also be supported, including other 802.x communication protocols (e.g., WiMax, Wi-Fi, 3G), code division multiple access (CDMA), global system for mobile communications (GSM), Enhanced Data GSM Environment (EDGE), etc.

FIG. 25B illustrates another example of configurable top-level graphical user interface of device 2500. The device 2500 can be configured to display a different set of display objects.

In some implementations, each of one or more system objects of device 2500 has a set of system object attributes associated with it; and one of the attributes determines whether a display object for the system object will be rendered in the top-level graphical user interface. This attribute can be set by the system automatically, or by a user through certain programs or system functionalities as described below. FIG. 25B shows an example of how the Notes object 2552 (not shown in FIG. 25A) is added to and the Web Video object 2516 is removed from the top graphical user interface of device 2500 (e.g. such as when the attributes of the Notes system object and the Web Video system object are modified).

FIG. 30 is a block diagram 3000 of an example implementation of a mobile device (e.g., mobile device 2500). The mobile device can include a memory interface 3002, one or more data processors, image processors and/or central processing units 3004, and a peripherals interface 3006. The memory interface 3002, the one or more processors 3004 and/or the peripherals interface 3006 can be separate components or can be integrated in one or more integrated circuits. The various components in the mobile device can be coupled by one or more communication buses or signal lines.

Sensors, devices, and subsystems can be coupled to the peripherals interface 3006 to facilitate multiple functionalities. For example, a motion sensor 3010, a light sensor 3012, and a proximity sensor 3014 can be coupled to the peripherals interface 3006 to facilitate the orientation, lighting, and proximity functions described with respect to FIG. 25A. Other sensors 3016 can also be connected to the peripherals interface 3006, such as a positioning system (e.g., GPS receiver), a temperature sensor, a biometric sensor, or other sensing device, to facilitate related functionalities.

A camera subsystem 3020 and an optical sensor 3022, e.g., a charged coupled device (CCD) or a complementary metal-oxide semiconductor (CMOS) optical sensor, can be utilized to facilitate camera functions, such as recording photographs and video clips.

Communication functions can be facilitated through one or more wireless communication subsystems 3024, which can include radio frequency receivers and transmitters and/or optical (e.g., infrared) receivers and transmitters. The specific design and implementation of the communication subsystem 3024 can depend on the communication network(s) over which the mobile device is intended to operate. For example, a mobile device can include communication subsystems 3024 designed to operate over a GSM network, a GPRS network, an EDGE network, a Wi-Fi or WiMax network, and a Bluetooth™ network. In particular, the wireless communication subsystems 3024 may include hosting protocols such that the mobile device may be configured as a base station for other wireless devices.

An audio subsystem 3026 can be coupled to a speaker 3028 and a microphone 3030 to facilitate voice-enabled functions, such as voice recognition, voice replication, digital recording, and telephony functions.

The I/O subsystem 3040 can include a touch screen controller 3042 and/or other input controller(s) 3044. The touch-screen controller 3042 can be coupled to a touch screen 3046. The touch screen 3046 and touch screen controller 3042 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen 3046.

The other input controller(s) 3044 can be coupled to other input/control devices 3048, such as one or more buttons, rocker switches, thumb-wheel, infrared port, USB port, and/or a pointer device such as a stylus. The one or more buttons (not shown) can include an up/ down button for volume control of the speaker 3028 and/or the microphone 3030.

In one implementation, a pressing of the button for a first duration may disengage a lock of the touch screen 3046; and a pressing of the button for a second duration that is longer than the first duration may turn power to the mobile device on or off. The user may be able to customize a functionality of one or more of the buttons. The touch screen 3046 can, for example, also be used to implement virtual or soft buttons and/or a keyboard.

In some implementations, the mobile device can present recorded audio and/or video files, such as MP3, AAC, and MPEG files. In some implementations, the mobile device can include the functionality of an MP3 player, such as an iPod™. The mobile device may, therefore, include a 32-pin connector that is compatible with the iPod™. Other input/output and control devices can also be used.

The memory interface 3002 can be coupled to memory 3050. The memory 3050 can include high-speed random access memory and/or non-volatile memory, such as one or more magnetic disk storage devices, one or more optical storage devices, and/or flash memory (e.g., NAND, NOR). The memory 3050 can store an operating system 3052, such as Darwin, RTXC, LINUX, UNIX, OS X, WINDOWS, or an embedded operating system such as VxWorks. The operating system 3052 may include instructions for handling basic system services and for performing hardware dependent tasks. In some implementations, the operating system 3052 can be a kernel (e.g., UNIX kernel).

The memory 3050 may also store communication instructions 3054 to facilitate communicating with one or more additional devices, one or more computers and/or one or more servers. The memory 3050 may include graphical user interface instructions 3056 to facilitate graphic user interface processing; sensor processing instructions 3058 to facilitate sensor-related processing and functions; phone instructions 3060 to facilitate phone-related processes and functions; electronic messaging instructions 3062 to facilitate electronic-messaging related processes and functions; web browsing instructions 3064 to facilitate web browsing-related processes and functions; media processing instructions 3066 to facilitate media processing-related processes and functions; GPS/Navigation instructions 3068 to facilitate GPS and navigation-related processes and instructions; camera instructions 3070 to facilitate camera-related processes and functions; and/or other software instructions 3072 to facilitate other processes and functions, e.g., access control management functions as described in reference to FIGS. 5 and 6. The memory 3050 may also store other software instructions (not shown), such as web video instructions to facilitate web video-related processes and functions; and/or web shopping instructions to facilitate web shopping-related processes and functions. In some implementations, the media processing instructions 3066 are divided into audio processing instructions and video processing instructions to facilitate audio processing-related processes and functions and video processing-related processes and functions, respectively. An activation record and International Mobile Equipment Identity (IMEI) 3074 or similar hardware identifier can also be stored in memory 3050.

Each of the above identified instructions and applications can correspond to a set of instructions for performing one or more functions described above. These instructions need not be implemented as separate software programs, procedures, or modules. The memory 3050 can include additional instructions or fewer instructions. Furthermore, various functions of the mobile device may be implemented in hardware and/or in software, including in one or more signal processing and/or application specific integrated circuits.

### Closing

The disclosed and other embodiments and the functional operations described in this specification can be implemented in digital electronic circuitry, or in computer software, firmware, or hardware, including the structures disclosed in this specification and their structural equivalents, or in combinations of one or more of them. The disclosed and other embodiments can be implemented as one or more computer program products, i.e., one or more modules of computer program instructions encoded on a computer-readable medium for execution by, or to control the operation of, data processing apparatus. The computer-readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal (e.g., a machine-generated electrical, optical, or electromagnetic signal), that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code).

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, the disclosed embodiments can be implemented on a computer having a display device, e.g., a CRT (cathode ray tube), LCD (liquid crystal display) monitor, touch sensitive device or display, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

While this specification contains many specifics, these should not be construed as limitations on the scope of what is being claimed or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understand as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

Although a few implementations have been described in detail above, other modifications are possible. For example, the flow diagrams depicted in the figures do not require the particular order shown, or sequential order, to achieve desirable results. In addition, other steps may be provided, or steps may be eliminated, from the described flow diagrams, and other components may be added to, or removed from, the described systems. Accordingly, various modifications may be made to the disclosed implementations and still be within the scope of the following claims.

1. A method comprising:
providing a user interface allowing the insertion of elements into a document flow comprising static and dynamic elements, the user interface presenting a graphical depiction of the document that is dynamically altered by the insertion of the element, wherein the dynamically altered appearance of the document correctly reflects the position and type of the inserted element and rearranges all existing static and flow elements of the document around the inserted element.

2. The method of claim 1, wherein the user interface is configured to insert into the document flow any element from a predefined library containing at least a box element, a browser element, a button element, an input control element, a gauge element, and combinations thereof.

3. The method of claim 1, wherein the user interface is configured to insert into the document flow elements and non-flow elements.

4. The method of claim 1, wherein the user interface provides that an underlying code of the document flow is modified based on the inserted element and the rearranged static and dynamic elements.

5. A method comprising:
detecting the movement of an element of a layout of a document outside a boundary of a first level of hierarchy; and
visually and in the underlying code, placing that element in a level of hierarchy that is a parent of the first level of hierarchy.

6. The method of claim 5, wherein the movement begins in another element at the first level that is configured to contain the element at the first level, and wherein the movement outside the boundary comprises that the element is placed at the parent of the first level instead of being placed at the first level.

7. The method of claim 5, wherein a user graphically moves the element by dragging the element using a pointing device.

8. A method comprising:
refactoring an interface for content editing based on a project type.

9. The method of claim 3 where the project type is defined using a property list for the project type.

10. The method of claim 8, further comprising providing at least one of templates, attributes, library parts, views, icons, variable elements based on the project type.

11. The method of claim 8, further comprising choosing a deployment behavior based on the project type.

12. The method of claim 8, wherein the refactoring is performed in a tool that includes templates for web applications and for web widgets, and wherein a user selects one of the templates in the tool and the property list is provided from the selected template.

13. The method of claim 12, wherein the tool provides a list view and at least one template row, further comprising receiving a modification of the template row and applying the modification to any other row that relates to the template row.

14. The method of claim 13, further comprising adding an element to the list view, adding the element to the template row, and updating all rows of the list relating to the template row.

15. A method comprising:
Generating a replicated element based on the editing of a canonical element and mapping corresponding subcomponents of the canonical element to corresponding subcomponents of the replicated elements.

16. The method of claim 15 further comprising maintaining a dictionary to map identifiers of a subcomponent of a replicated element to an identifier of a subcomponent of the canonical element.

17. The method of claim 15, further comprising invoking a function that receives a cloned row relating to a template row, the cloned row having an attribute that contains a reference to each element in the cloned row, wherein the function changes an aspect of the cloned row based on the attribute.

18. A method comprising: running a debug plug in in a mobile device to monitor a web application and reporting data to a web application development tool.

19. The method of claim 18, Further comprising presenting a resource logging interface for the web application, the resource logging interface configured to be filtered.

20. The method of claim 18, Further comprising providing graphical representations of memory, CPU and network use to indicate CPU usage or memory.

21. A method comprising: running a debug plug in a simulator of a mobile device to monitor a web application and reporting data to a web application development tool

22. The method of claim 21, further comprising monitoring a web application on both a mobile device and on a simulation of a mobile device connected to a debugging interface using plug-ins in a browser of the mobile device and a browser of the simulation of the mobile device.

23. The method of claim 21, Further comprising presenting a resource logging interface for the web application, the resource logging interface configured to be filtered.

24. The method of claim 21, Further comprising providing graphical representations of memory, CPU and network use to indicate CPU usage or memory.

25. A method comprising: depicting content intended for a mobile device at a scale related to the pixel resolution of the device in a simulation of the device.

26. The method of claim 25, wherein the depicted content is a pixel-to-pixel analog of the mobile device.

27. The method of claim 25, further comprising resealing to a 1:1 dimensionally accurate analog of a view on the mobile device.

28. A method comprising: depicting content intended for a mobile device at a scale related to the physical dimensions the device in a simulation of the device.

29. The method of claim 28, further comprising simulating a rotation to be performed on the mobile device.

30. The method of claim 29, wherein simulating the rotation comprises determining, before simulating the rotation, each aspect of the depicted content; determining how each aspect should appear after rotation on the mobile device; and performing the rotation based on at least on the two determinations.

31. A method to allow a visualization of content intended for a mobile device at a first scale related to the pixel resolution of the device in a simulation of the device or at a second scale related to the physical dimensions the device in the simulation of the device in response to a user input.

32. The method of claim 31, Further comprising selectively performing the visualization at at least one of the first scale or the second scale.

33. The method of claim 32, wherein the visualization is performed at one of the first and second scales based on a user input.

34. A method comprising: listing all resources accessed by a web application or a web widget and filtering them based on one or more of network location and resource type.

35. The method of claim 34, wherein a user selects one of the resources, further comprising displaying information regarding the selected resource.

36. The method of claim 35, further comprising toggling to display the resource instead of the displayed information.

37. A method comprising displaying information comprising CPU, memory and network bandwidth usage of only those processes required to display or run a particular web application or widget.

38. The method of claim 37, wherein the information is displayed in a debug plug in in a mobile device that monitors a web application and reports data to a web application development tool.

39. The method of claim 37, wherein the information is displayed in a debug plug in a simulator of a mobile device that monitors a web application and reports data to a web application development tool.
